(19) United States
(12) Patent Application Publication
(10) Pub. No.: US 2024/0116830 A1
(43) Pub. Date: Apr. 11, 2024

(54) SYSTEMS AND METHODS FOR PHOSPHATE PROCESSING

(71) Applicant: Ahren BRITTON

(72) Inventor: Ahren BRITTON

(21) Appl. No.: 17/768,452

(22) PCT Filed: Oct. 16, 2020
(86) PCT No.: PCT/CA2020/051395

§ 371 Date: Apr. 12, 2022

(51) Int. Cl. C05B 7/00; C02F 1/00; C02F 1/52; C05B 19/00

(52) U.S. Cl. CPC C05B 7/00; C02F 1/004; C02F 1/52; C05B 19/00

(57) ABSTRACT

Embodiments described herein provide systems and methods for a phosphate processing system with integrated sub-systems, such as a phosphoric acid plant, precipitation system, crystallizer system, rinsing system, granulation system, pond water system, organics removal system, and/or exhaust treatment system. Such sub-systems can be integrated with each other by using one or more output streams from one or more sub-systems as one or more input streams for one or more sub-systems. In some embodiments, the phosphate processing system can produce phosphoric acid, struvite containing fertilizer, fertilizer using recycled struvite, magnesium or fluoride containing compositions using recycled magnesium or fluoride, and other components using phosphoric acid collected from a phosphoric acid and gypsum composition or using sludge collected from a waste stream, for example.

### CROSS-REFERENCE TO RELATED APPLICATION

This application claims priority from U.S. application No. 62/916,584 filed 17 Oct. 2019 and entitled SYSTEMS AND METHODS FOR PHOSPHATE PROCESSING which is hereby incorporated herein by reference for all purposes. For purposes of the United States of America, this application claims the benefit under 35 U.S.C. § 119 of U.S. application No. 62/916,584 filed 17 Oct. 2019 and entitled SYSTEMS AND METHODS FOR PHOSPHATE PROCESSING.

### TECHNICAL FIELD

Some embodiments of the present invention relate generally to systems and methods for processing phosphate and more particularly to integration of processing systems for phosphate.

### BACKGROUND

Phosphoric acid can be produced by a “wet process” which involves reacting naturally occurring phosphate rocks with a mineral acid such as sulfuric, phosphoric acid or nitric acid. In addition to the phosphoric acid, a solid precipitate is formed as a by-product. If sulfuric acid is used as the digesting acid, the precipitate will include gypsum (mostly calcium sulfate) as its major constituent. Such precipitate is known as “phosphogypsum”.

The phosphoric acid is typically separated from the insoluble gypsum precipitate by filtration. The gypsum is removed in the form of a filter cake. An appreciable amount of phosphoric acid can be entrapped in the filter cake. The phosphoric acid entrapped in the filter cake constitutes a substantial portion of phosphate yield loss in the production process.

Phosphate rocks are typically produced from mining (i.e., removing phosphate ore from the ground) followed by a beneficiation process to separate sand and clay to remove impurities. Phosphate rock contains various amounts of impurities. One impurity that is often present in phosphate rocks is dolomite, which is a source of magnesium oxide (MgO). Magnesium is one of the most undesirable impurities in phosphate rock. The presence of Mg causes difficulties both in the flotation and phosphoric acid production processes. For example, magnesium ions form precipitates in the reaction mixture. Reaction mixtures which contain high amounts of magnesium precipitates can clog up the filter media. The filtration rate of the reaction mixture to recover the phosphoric acid product is also low. It is difficult and costly to remove the phosphoric acid in such reaction mixtures.

There is typically a desire to avoid such low-grade phosphate rocks which contain high magnesium content. However, avoidance of such low-grade phosphate rocks is not always possible and it would be desirable to have an economically viable way to process such low grade phosphate rocks. There is thus a desire for a cost-effective process to make use of these low-grade phosphate rocks to produce useful end products, and more particularly, without the need to first purify these low-grade rocks to remove the magnesium impurities prior to product production.

In the wet process production of phosphoric acid, large volumes of contaminated water are generated. The contaminated water is generally discharged. The discharged water is commonly known as “pond water”.

Pond water may also include water drained from gypsum stacks and other water that is used in and around the phosphoric acid plant, such as for cleaning or washing, fresh water fume scrubbers, and phosphoric acid spills or leaks within the plant. The pond water is highly acidic. It contains a dilute mixture of phosphoric, sulfuric, and fluosilicic acids. Pond water is typically saturated with gypsum and contains other ions found in the phosphate rock. The accumulation of pond water is hazardous to the environment. It requires significant costs to treat the pond water before it can be safely discharged.

There are existing methods for treating pond water and/or for recovering valuable products from the pond water. One of such methods is known as double lime treatment. This method involves adding a calcium compound (e.g., CaCO₃, Ca(OH)₂ or CaO) to the pond water in two stages to precipitate phosphate and other impurities to produce purified water. Another existing method is reverse osmosis. Reverse osmosis involves applying an external pressure that exceeds the osmotic pressure of the water component of an aqueous salt solution that is in contact with a semi-permeable membrane. This forces some of the water through the membrane in the reverse direction while the other components in the solution do not pass through the membrane, resulting in a stream of purified water and a stream of increased salt content which would be discarded or returned to the storage pond.

Ideally, the collected pond water is continuously recycled to the phosphoric acid production plant for reuse, for example as a water source for the phosphoric acid, for washing the gypsum filter cake, for gas scrubbing, to slurry the gypsum produced, and other purposes that do not require fresh water. An efficiently operated phosphoric acid plant strikes a balance between water input and water evaporation so that virtually all of the contaminated water is directed to be reused within the plant. This eliminates the need to treat and discharge the contaminated pond water as long as the plant continues to operate.

There is a need for ways to make production of phosphoric acid more efficient, more environmentally sustainable and/or more economically viable. There is a particular need for efficient ways to process low grade phosphate rock that contains significant quantities of magnesium.

### SUMMARY

This invention has a number of aspects. Some of these aspects exploit synergies between different processes that can be applied to processing phosphate-containing materials to generate useful products. These synergies may be exploited individually or in any combination(s). The invention may be applied to processing phosphate pond water but also has application to processing sources of phosphate.

Processes that may be synergistically combined as described herein include:
production of phosphoric acid;
production of granular fertilizer;
removing dissolved materials from pond water or other solutions by precipitation;
crystallizing struvite, struvite analogs or other phosphorus-containing compounds;
making fertilizers (in some embodiments by production of a homogenous granule, for example, using methods and compositions as described in U.S. Pat. No. 9,878,960 entitled “Slow and fast release fertilizer composition and methods for making same”, the entire contents of which are herein incorporated by reference); and/or
mining phosphate rock.

Some aspects of the invention provide improvements to apparatus and methods useful for processing phosphate-containing materials including:
production of phosphoric acid;
production of granular fertilizer;
production of monoammonium phosphate (MAP), diammonium phosphate (DAP) and/or struvite;
removing dissolved materials from pond water or other solutions by precipitation;
crystallizing struvite, struvite analogs or other magnesium phosphate containing compounds;
making fertilizers (in some embodiments by production of a homogenous granule, for example, using methods and compositions as described in U.S. Pat. No. 9,878,960 entitled “Slow and fast release fertilizer composition and methods for making same”, the entire contents of which are herein incorporated by reference); and/or
mining phosphate rock.

In some embodiments struvite is produced in combination with processing phosphate rock to obtain phosphoric acid. Such embodiments may advantageously use as a feedstock a phosphate rock that has a high Mg content. In such embodiments a higher water content may be maintained in process liquids being processed to yield phosphoric acid. This in turn facilitates the import/use of fresh water for rinsing gypsum filter cake to achieve an increased yield of phosphate while maintaining a negative water balance in the process (i.e. the process tends to consume more water at inputs than it produces as outputs).

In some embodiments phosphoric acid is produced in a system that also includes a granulation plant (which may for example, produce granulated materials comprising struvite). Such embodiments may use sludge which is a by product of phosphoric acid production as an input to the granulation plant and/or integrate handling of granulation plant dust emissions/scrubber water in pond water treatment system clarifiers with treatment of pond water and/or use treated water streams to rinse gypsum filter cake to increase phosphoric acid yield. This may be done while maintaining an overall negative water balance.

One aspect of this invention provides a phosphate processing system. The phosphate processing system pertains to synergistically combining some or all of the processes described above to enhance end product recovery while reducing environmental impacts and costs relating to hazardous waste generated from fertilizer production. The phosphate processing system of this invention ideally operates with a negative water balance to avoid treatment and discharge of contaminated pond water.

Some embodiments of the phosphate processing system produce phosphoric acid from low-grade phosphate rocks. The low-grade phosphate rocks comprise high magnesium content which is conventionally undesirable for phosphoric acid and fertilizer production. Embodiments of this system make use of such low-grade phosphate rocks to produce phosphoric acid. Increased water input may be used in the phosphoric acid production to produce a more dilute phosphoric acid. A dilute phosphoric acid product mitigates some of the challenges around filtering the reaction mixture in the presence of magnesium precipitates. Embodiments of the phosphate processing system involve producing a struvite-based fertilizer from the dilute phosphoric acid product. The magnesium contained in the low-grade phosphate rock may be used as a magnesium source in the fertilizer granulation process. The excess water contained in the dilute phosphoric acid product may be used as a water source in the fertilizer granulation process. The fertilizer granulation process may involve the production of struvite-containing fertilizers.

Some embodiments of the phosphate processing system pertain to improving phosphoric acid recovery from by-products. One of the processes to recover phosphoric acid is from rinsing or washing the gypsum filter cake that is generated from separating the gypsum by-product from phosphoric acid. In some embodiments, fresh water is used to rinse the gypsum filter cake to recover the phosphoric acid entrapped within the filter cake. In some embodiments, treated water is used to rinse the gypsum filter cake. The treated water may be water purified from the pond water. The pond water collects excess water discharged from the phosphoric acid plant. The pond water purification process produces a stream of purified water and a stream of sludge containing phosphate as by-product. Some embodiments involve recycling the sludge to the phosphoric acid plant for recovery of phosphoric acid entrapped in the sludge.

Some embodiments of the phosphate processing system pertain to combining an exhaust treatment system with the phosphoric acid plant and a granulation system. The exhaust treatment system includes processes to remove solid particles and vapours produced during the granulation process. The removed solid particles may be recovered and recycled for use in the granulation process. Alternatively, the removed solid particles may be crystallized to recover phosphorus, for example, in the form of phosphate containing products such as struvite. The struvite may be fed into the granulation system for making struvite-based fertilizers.

In some embodiments, there is provided a method for producing phosphoric acid, including receiving a phosphate sludge from a phosphogypsum treatment system; processing the sludge to produce phosphoric acid in a phosphoric acid plant; and optionally producing a composition having phosphoric acid and magnesium above a threshold value.

In some embodiments, there is provided a method for producing phosphoric acid and struvite, including receiving a phosphate source containing magnesium; processing the phosphate source; producing phosphoric acid from the phosphate source; and crystallizing struvite using the magnesium from the phosphate source.

In some embodiments, there is provided a method for producing phosphoric acid and struvite, including receiving a phosphate source containing magnesium; processing the phosphate source to produce phosphoric acid; and granulating struvite containing fertilizer using the magnesium.

In some embodiments, there is provided a method for crystalizing struvite, including receiving organic waste containing phosphate containing material; solubilizing the phosphate from the organic waste using partly treated pond water; removing organic matter from the organic phosphate containing material to form a phosphate containing solution; and crystallizing struvite using the phosphate containing solution.

In some embodiments, there is provided a method for granulating struvite containing fertilizer, including receiving effluent derived from a precipitated phosphorous containing solution; crystallizing struvite from the effluent; receiving phosphoric acid from a phosphoric acid plant; and granulating struvite containing fertilizer using the struvite and the phosphoric acid.

In some embodiments, there is provided a method for separating phosphoric acid from a gypsum-containing composition, including receiving an aqueous phosphate solution recovered from treated phosphogypsum pond water having an amount of phosphate below a threshold value; rinsing the gypsum-containing composition using the aqueous phosphate solution to produce an output stream; and collecting phosphoric acid from the output stream.

In some embodiments, there is provided a method for extracting phosphate from an organic waste, using a partially treated phosphogypsum pond water and using same to crystalize struvite.

In some embodiments, there is provided a method for granulation to produce fertilizer, the method including receiving phosphoric acid produced as a by-product from sludge produced in treatment of phosphogypsum pond water.

In some embodiments, there is provided a method for concentrating a stream using a membrane for nanofiltration or reverse osmosis to provide an output stream concentrated for one or more components for use in a system.

Further aspects and embodiments will become apparent by reference to the drawings and by study of the following detailed descriptions.

### BRIEF DESCRIPTION OF THE DRAWINGS

Embodiments are illustrated in referenced figures of the drawings. It is intended that the embodiments and figures disclosed herein are to be considered illustrative rather than restrictive.

Embodiments will now be described by way of example only with reference to the drawings, wherein in the drawings:

FIG. 1 is a schematic diagram of an example phosphate processing system, according to some embodiments; and

FIG. 2 is a schematic diagram of an example phosphate processing system, according to some embodiments.

FIG. 3 is a schematic diagram showing selected processes in the FIG. 2 example phosphate processing system.

FIG. 4 is a schematic diagram showing selected processes in the FIG. 2 example phosphate processing system.

FIG. 5 is a schematic diagram showing selected processes in the FIG. 2 example phosphate processing system.

FIG. 6 is a schematic diagram showing selected processes in the FIG. 2 example phosphate processing system.

FIG. 7 is a schematic diagram showing selected processes in the FIG. 2 example phosphate processing system.

### DESCRIPTION

Throughout the following description specific details are set forth in order to provide a more thorough understanding to persons skilled in the art. Accordingly, the description and drawings are to be regarded in an illustrative, rather than a restrictive, sense.

In some embodiments, there is provided an integrated system for managing phosphate that includes one or more component sub-systems. This disclosure describes an example integrated system as a way to explain the various synergies and improvements that are being described. However, some inventions described herein may be practiced using only one or more parts of the described integrated system.

In some embodiments, certain component sub-systems can be omitted. In some embodiments, certain other component sub-systems can be included. In some embodiments, sub-systems can be arranged in relation to each other, integrated, and/or selected in different ways.

For example, an integrated system for managing phosphate can include some or all of:
systems for producing phosphoric acid (e.g., from phosphate rock, phosphate pond water, waste water etc.),
systems for producing gypsum (e.g., as a waste stream when producing phosphoric acid or as a precipitate),
systems for precipitating material (e.g., to collect phosphate-containing material and/or other materials from pond water, process water, waste water or other sources),
systems for rinsing material (e.g., rinsing gypsum produced in a phosphoric acid reactor as a by-product of a reaction between phosphate rock and sulfuric acid to collect associated phosphoric acid),
crystallizers for crystalizing compounds (e.g., struvite crystallization from input sources such as pond water, process water, waste water, exhaust scrubbers processing exhaust streams from granulating or co-granulation of fertilizer or phosphoric acid production),
systems for granulating or co-granulating material (e.g., to produce fertilizer using phosphoric acid and other material),
combinations of any two or more of these sub-systems or other systems.

These and other systems can be integrated in various ways, for example, with outputs from certain system(s) used as inputs to other system(s). Such integration can help reduce or mitigate environmental impacts that can arise from mining phosphate rock, managing phosphate, processing phosphate, producing fertilizer from phosphate-containing material, and other industrial processes. For example, integration can reduce the amount of fresh water used or polluted by reusing waste water outputted from some sub-systems as an input to other sub-systems.

Where appropriate, integration may comprise using output stream(s) from one sub-system as input stream(s) in other sub-systems. In some embodiments, one or more sub-systems of a phosphate processing system mitigate the environmental impact of a phosphoric acid plant by re-using one or more constituent components of its output stream(s) (e.g., struvite, phosphorus, phosphate, phosphoric acid, magnesium, fluoride, gypsum, organic material, water) and/or by reducing the amount or concentration of phosphorus-containing material in its output stream(s) (e.g., mitigating the impact of any output stream produced by the phosphoric acid plant that has a high concentration of phosphoric acid).

Throughout this description, “stream” means a flow of material. Subsystems may receive one or more streams as inputs and may produce one or more streams as outputs. Streams may carry matter in any state. For example, a flow of any of the following materials can be called a “stream”: phosphoric acid, a phosphate rock, a phosphate rock immersed in a solution, gypsum with phosphoric acid associated with it, effluent, a treated or partially treated wastewater or process water, an acidic solution, a slurry, a sludge, a cogranulated composition, fines, a drying agent, fertilizer, an organic waste stream (manure, food waste, biomass, etc.), etc.

Throughout the description, the term “co-granulation” includes production of a homogenous granule and “cogranulated” material or composition includes a homogenous granule. A homogenous granule can be a granule or composition that is homogenous, substantially homogenous, or homogenous with respect to one or more constituent components, such as gypsum, struvite, magnesium, fluoride, or the like.

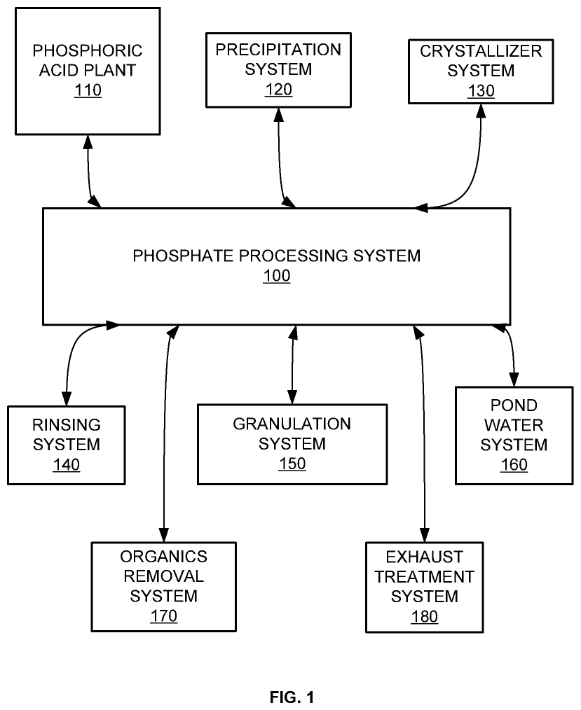

FIG. 1 is a schematic diagram of an example phosphate processing system 100, according to some embodiments. As shown, phosphate processing system 100 includes phosphoric acid plant 110, precipitation system 120 (in some embodiments, is a treatment system 120), crystallizer system 130, rinsing system 140, granulation system 150, pond water system 160, organics removal system 170, and exhaust treatment system 180. As mentioned above, one or more of these subsystems may be selectively omitted and/or one or more other systems can be selectively included.

FIG. 1 illustrates example paths which carry streams output by systems included in phosphate processing system 100 to inputs of systems included in phosphate processing system 100 (e.g., to the same system such as in a feedback loop; to a different system).

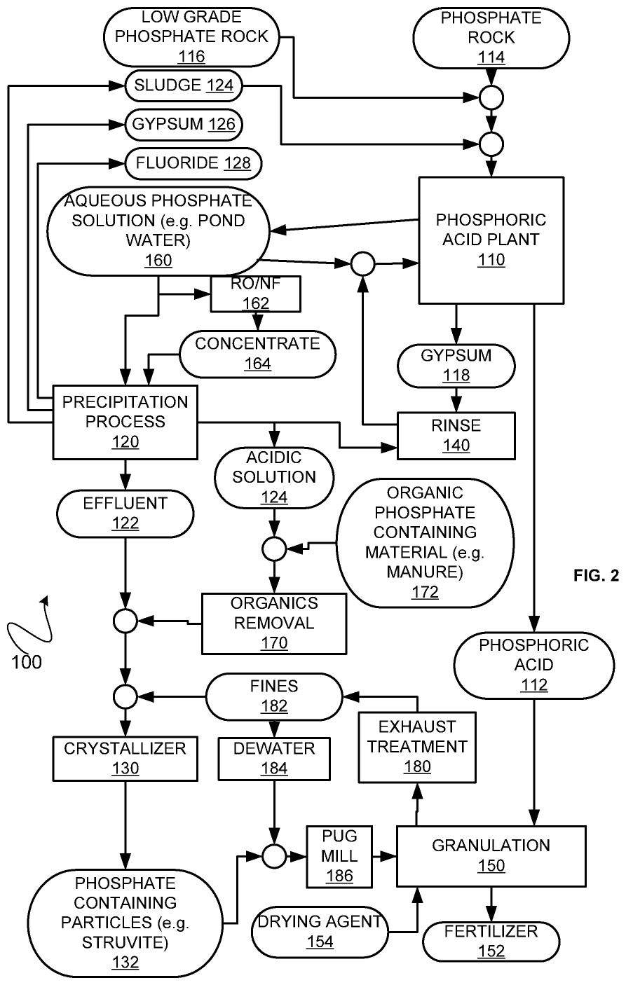

FIG. 2 is a schematic diagram of an example phosphate processing system 100, according to some embodiments. The phosphate processing system 100 includes a phosphoric acid plant 110, precipitation system 120, crystallizer system 130, gypsum rinsing system 140, granulation system 150, pond water (or process/cooling water system) 160 (e.g., aqueous phosphate solution), organics removal system 170, and/or exhaust treatment system 180. In other embodiments, one or more systems and/or steps are omitted from and/or added to phosphate processing system 100.

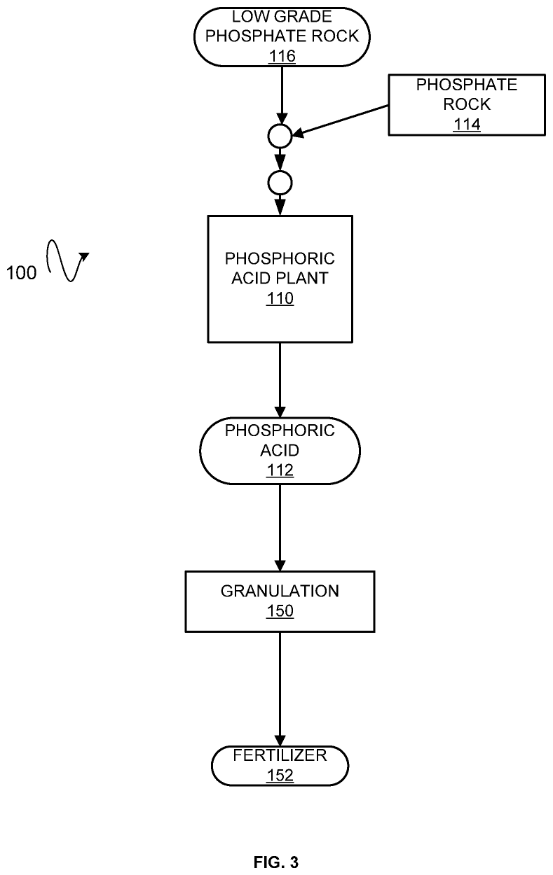

FIGS. 3 to 7 illustrate selected synergies within phosphate processing system 100 in detail. Phosphate processing system 100 relies on the synergistic combination of processes to provide one or more of the following:
produce phosphoric acid and/or fertilizers from low-grade phosphate rocks containing high levels of magnesium with end products that are of sufficiently high yield and purity;
recovery of struvite from crystallization of reaction by-products and/or other waste products generated within the plant for use in the granulation process to produce struvite-based fertilizers;
enhance phosphoric acid yield by recycling by-products from various streams into the phosphoric acid plant; and
maintain a negative water balance within the plant.

Referring to FIG. 3, one embodiment of the phosphate processing system 100 combines phosphoric acid plant 110 with granulation system 150 to produce fertilizer products 152. In some embodiments, a low-grade phosphate rock 116 is used as the raw material in the production of phosphoric acid 112. The low-grade phosphate rock 116 may contain an elevated amount of dolomite (MgO) (and/or other magnesium source). Magnesium is generally considered to be one of the most undesirable impurities in phosphoric acid production. For example, elevated magnesium content increases the viscosity of the liquid phase in the reaction medium and decreases the kinetics and crystalline growth of gypsum. It also contributes to the formation of insoluble complex mineral phases, which can result in equipment fouling problems and considerable losses of phosphorus.

To mitigate these issues, a more dilute phosphoric acid product 112 with higher water content can be produced. A more dilute phosphoric acid product 112 can for example be produced by using increased inputs of water, or reduced evaporative concentration of the phosphoric acid product 112. The increased water input can be from any suitable sources such as undried phosphate rock, wet grinding of phosphate rock, use of dilute sulfuric acid or input of fresh or processed water.

The dilute phosphoric acid product 112 can be supplied as a feedstock to a reactor or granulator for crystallization of struvite, another Mg containing material (e.g. MAP or DAP) or a mixture thereof.

Struvite is a compound which has the formula: NH₄MgPO₄·6H₂O. Crystallizing struvite from the dilute phosphoric acid product removes magnesium. Crystallizing struvite from the dilute phosphoric acid product also removes water which increases the concentration of dilute phosphoric acid product 112. Producing phosphoric acid that is more dilute (e.g. less than 54% P₂O₅ by weight) can facilitate using lower grade phosphate ores. Using the more dilute phosphoric acid to create struvite can help to make the overall process have a negative or neutral water balance (despite providing more dilute phosphoric acid) since making struvite consumes water. Providing an overall process that has negative or neutral water balance can advantageously reduce or eliminate production of wastewater and/or the need to treat wastewater.

Where phosphoric acid 112 contains a significant amount of Mg the Mg in phosphoric acid 112 may contribute to the Mg required for struvite production (and thereby reduce the requirement for other sources of Mg).

In some embodiments phosphoric acid 112 contains more than 0.5% or more than 1% or more than 3% or more than 5% MgO. In some embodiments phosphoric acid 112 contains Mg at a concentration such that a mole ratio of Mg:P in phosphoric acid 112 is in the range of 1:25 to 1:2 or 1:7 to 1:2 or 1:6 to 1:3 or the amount of Mg is high enough that the mole ratio of Mg:P in phosphoric acid 112 is greater than 1:15 or 1:7 or or 1:5 or 1:4.

The resulting struvite may be used, for example, in the production of fertilizers. The processing system of FIG. 1 can use the magnesium in low-grade phosphate rock 116 as a magnesium source in fertilizer while avoiding problems that are normally caused by excess magnesium.

In some embodiments granulation system 150 receives supplies of ammonia (e.g. as a gas or cryogenic liquid) and an additional magnesium source. Phosphoric acid 112 may be sprayed into a rotating drum into which ammonia is sparged. The additional Mg may be added as a powder or slurry of a Mg source. Phosphoric acid 112 and the ammonia react with the Mg contained in phosphoric acid 112 and the additional Mg to yield struvite and/or other compounds comprising ammonium, phosphate and magnesium. Optionally some ammonia may be contacted with phosphoric acid 112 before phosphoric acid 112 is introduced to granulator 150. This neutralizes or partly neutralizes phosphoric acid 112.

As granulator 150 operates, solids may be removed and sorted by size. Solids in a desired size range may be taken off (e.g. for use as a fertilizer or constituent of fertilizer). Fines may e recycled back into granulator 150. Solid particles that are larger than the desired size range may be crushed and recycled into granulator 150.

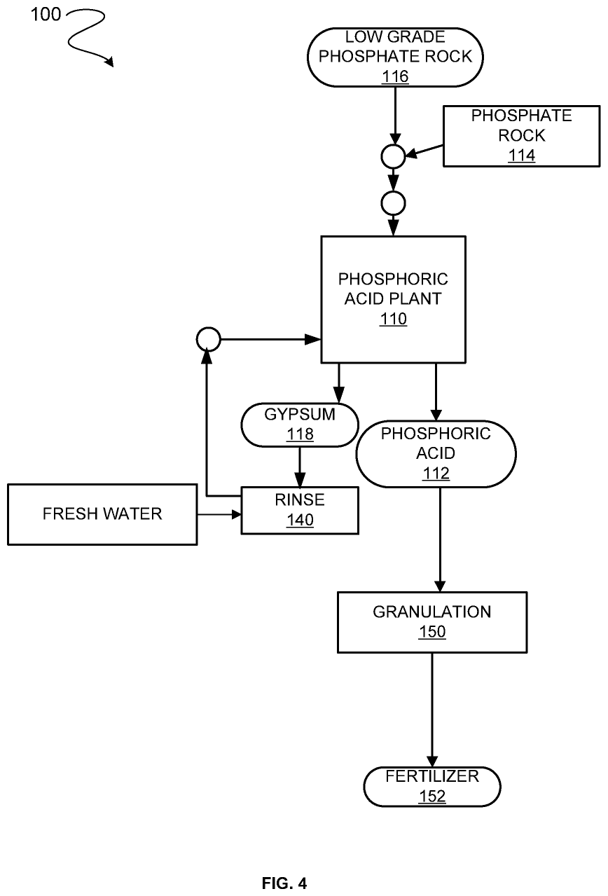

FIG. 4 illustrates an embodiment of the phosphate processing system 100 which combines rinsing system 140 with the FIG. 3 synergies, i.e., phosphoric acid plant 110 combined with granulation system 150 to produce fertilizer products 152. Rinsing system 140 is operative to rinse gypsum filter cake 118 that is generated in the filtration of the products (i.e., phosphoric acid 112 and the gypsum by-product 118) in the production of phosphoric acid. The gypsum filter cake 118 contains entrapped phosphoric acid. Rinsing the gypsum filter cake 118 recovers the entrapped phosphoric acid. The rinse water mixed with phosphoric acid may be returned to phosphoric acid plant 110 where the phosphoric acid may be recovered and the rinse water helps to maintain process liquids in the phosphoric acid plant dilute enough to avoid at least some of the problems mentioned above.

In some embodiments, fresh water is directed into rinsing system 140 to wash the gypsum filter cake 118. Further introduction of fresh water into a phosphoric acid plant is not conventionally desirable because of the need to further treat or discharge any excess contaminated water from the plant. However, in embodiments in which production of a dilute phosphoric acid product 112 is desirable (e.g., in the production struvite-based fertilizers using low-grade phosphate rocks as illustrated in FIG. 3), introduction of fresh water enhances the yield of phosphoric acid while maintaining an overall negative water balance within the plant.

In some embodiments rinsing system 140 rinses gypsum filter cake 118 in several stages. The rinsing system may be a countercurrent rinsing system in which gypsum filter cake 118 is rinsed two or more times with water that has been used in other stages of rinsing system 140 and is finally rinsed with fresh water. For example, where rinsing system 140 has four stages, fresh water may be supplied to rinse the gypsum filter cake 118 in the fourth stage, the water may be collected and supplied to rinse the gypsum filter cake 118 in the third stage, the water may be collected again and supplied to rinse the gypsum filter cake 118 in the second stage, the water may be collected again and supplied to rinse the gypsum filter cake 118 in the first stage. The rinse water (now containing phosphoric acid that has been washed out of gypsum filter cake 118) may then be returned to phosphoric acid plant 110 and/r mixed into phosphoric acid 112.

When fresh water is used to rinse gypsum filter cake 118 much more of the phosphoric acid entrapped in gypsum filter cake 118 can be captured than would be possible if rinsing were performed using pond water which already contains significant amounts of phosphate. However, where rinsing system 140 is included in a system which includes struvite production (e.g. in granulation system 150) the rinse water may be consumed in struvite production and therefore does not contribute to (or contributes less to) water that requires treatment before it can be released into the environment.

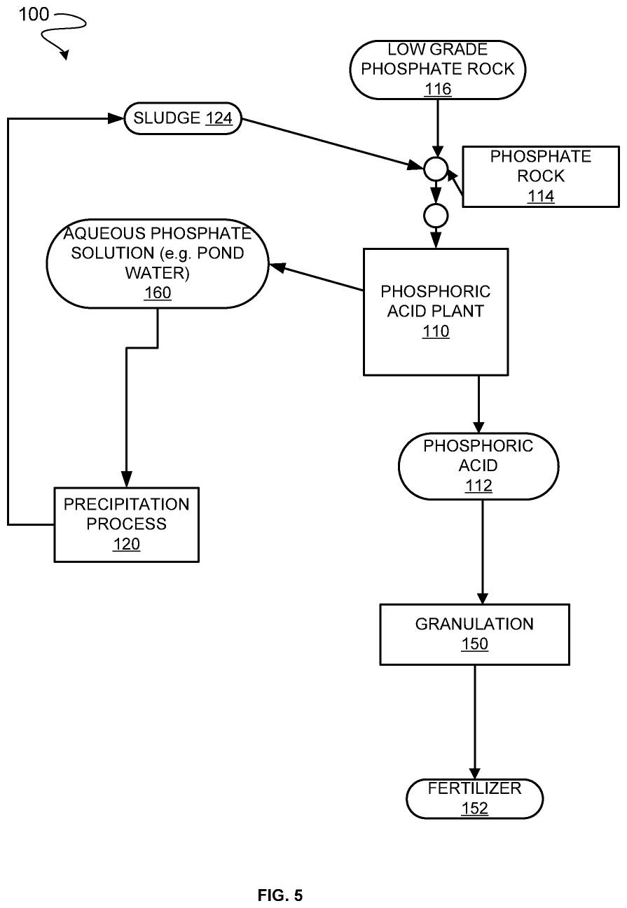

FIG. 5 illustrates another example combination of processes to improve phosphoric acid recovery. A flow of precipitated solids (i.e., sludge 124) is produced as a by-product in the precipitation of fluoride, phosphate and gypsum from the pond water at precipitation system 120. Sludge 124 may contain a mixture of the phosphate, precipitated impurities, un-reacted calcium compounds and water. Sludge 124 is recycled to phosphoric acid plant 110 for use in the production of phosphoric acid and thereby enhancing the overall yield of phosphoric acid in its production.

In some embodiments sludge 124 is produced in a multi stage process in which different stages yield sludges having different compositions. Sludge 124 may be selected from the sludges that have desired compositions for recycling into phosphoric acid plant 110. For example sludge 124 may be selected to be a sludge that contains more phosphate than other sludges that may be obtained in a multi stage precipitation process and/or sludge 124 may be selected as a sludge that contains less fluoride than other sludges that may be obtained in the multi-stage precipitation process.

Collecting and recycling a sludge 124 that contains phosphate can increase the yield of phosphoric acid and/or fertilizer from a given input of phosphate rock.

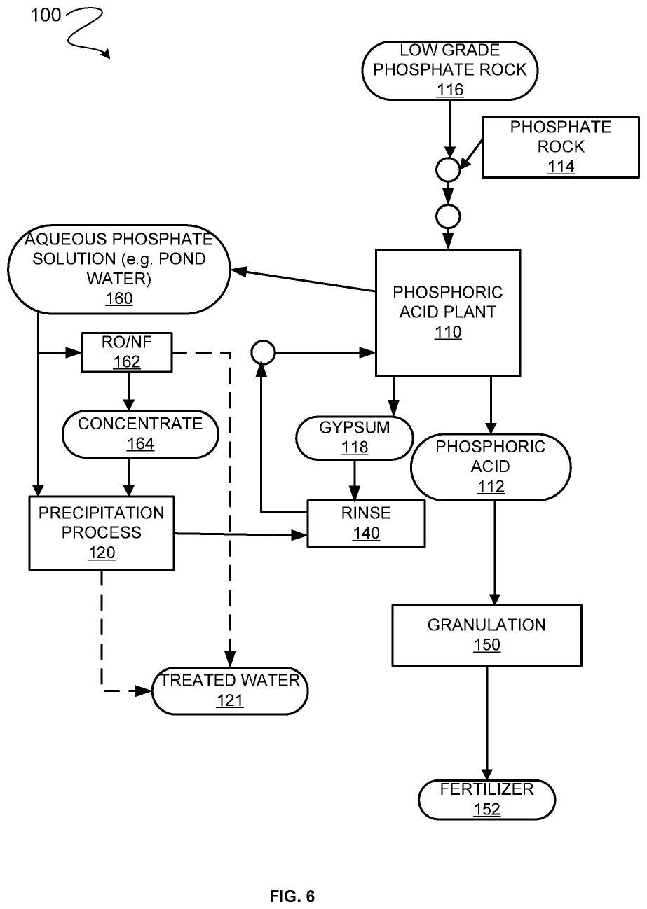

As shown in FIG. 6, another aspect of the invention provides a phosphate processing system 100 that combines pond water system 160 and precipitation system 120 with the FIG. 4 synergies, i.e., rinsing system 140 combined with phosphoric acid plant 110 and granulation system 150 to produce fertilizers 152. In this embodiment, treated water is directed into rinsing system 140 to wash the gypsum filter cake 118 (as opposed to using fresh water in the FIG. 4 embodiment).

The FIG. 6 processes uses the contaminated water (i.e., pond water 160) that is discharged from the phosphoric acid production at phosphoric acid plant 110. Pond water 160 is purified at precipitation system 120 (or first at reverse osmosis (RO) and/or nanofiltration (NF) system 162 followed by purification at precipitation system 120). The purified water may be used, for example, to rinse the gypsum filter cake 118 to recover entrapped phosphoric acid 112. This increases the yield of phosphoric acid 112 for input into granulation system 150 for producing fertilizers.

Treated water 121 may be used for various purposes including as rinse water supplied to rinsing system 140, as water for diluting phosphoric acid 112 and/or discharged into the environment.

By combining pond water treatment (e.g. as shown in FIG. 6) and recycling of sludge 124 (e.g. as shown in FIG. 5) one can consume pond water 160 while leaving reduced amount of sludge, thereby mitigating the significant environmental problem presented by pond water 160. For example, a plant that combines elements of FIGS. 5 and 6 may reduce the amount of pond water 160 associated with a phosphoric acid plane 110 over time as opposed to increasing the amount of pond water 160 associated with the phosphoric acid plant 110. This can provide significant environmental benefits since pond water 160 is generally highly acidic and presents a disposal problem.

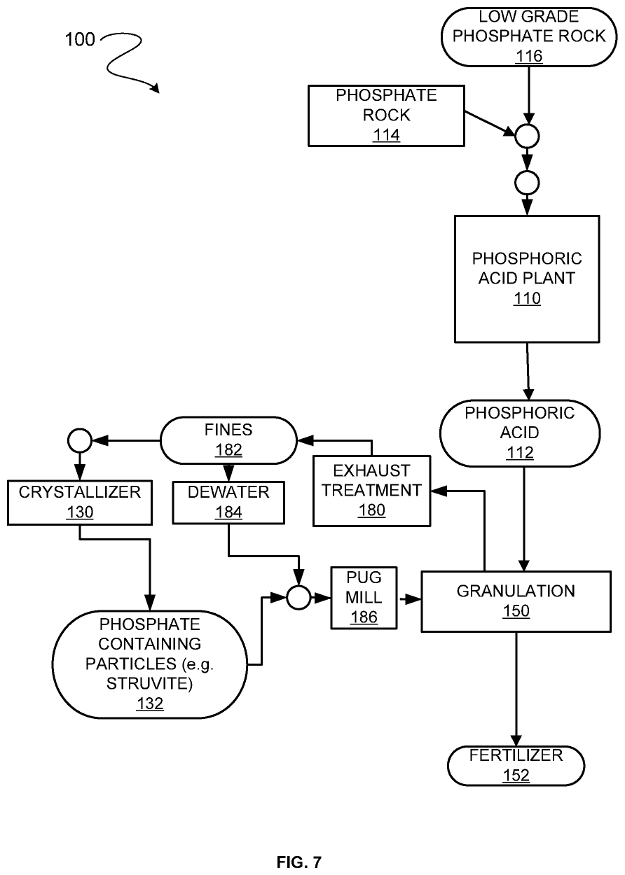

FIG. 7 illustrates combining an exhaust treatment system 180 with phosphoric acid plant 110 and granulation system 150. Exhaust treatment system 180 includes one or more processes configured to remove dust produced during fertilizer granulation. One example of such processes is the use of scrubbers. For example, wet scrubbers may be used to dissolve or suspend the dust in water and recover the dust as a low concentration solution or suspension in water. The scrubber solution or suspension comprises fines 182. In some embodiments, fines 182 are crystallized at crystallizer 130 to recover phosphorus, e.g., in the form of phosphate containing products 132. One of such by-products may be struvite. In some embodiments, fines 182 are recycled to granulation system 150. Fines 182 may include source materials that can be used in the granulating process.

Examples of source materials that can be recovered from fines 182 include urea and ammonium nitrate. Fines 182 may be first dewatered in an evaporation step 184 prior to being fed into a mixing device (e.g., pug mill 186) in fertilizer granulation.

FIG. 2 illustrates various synergies. FIG. 2 combines the various synergies described in FIG. 3 to 7 in a phosphate processing plant. FIG. 2 also includes in the phosphate processing plant other processes not specifically discussed in FIGS. 3 to 7. In some embodiments, phosphate processing system 100 provides integration of a process water treatment system (pre-treatment, struvite crystallization, and membrane treatment/polishing, for example, at precipitation system 120, crystallizer system 130, and RO/NF system 162, respectively), with gypsum filter rinsing (e.g., at rinsing system 140). In some embodiments, using the clean (e.g., low phosphate content) water from a membrane treatment step (e.g., water produced at 162) to provide fresh water makeup to the gypsum filter (e.g., when gypsum is rinsed at 140) allows the removal/recovery of a higher percentage of the phosphoric acid from the gypsum by-product.

As another example, in some embodiments, phosphate processing system 100 provides integration of a process water treatment system with emission control systems (e.g., at exhaust treatment system 180) associated with granulation of phosphoric acid to make granular fertilizer products. The granular fertilizer products can be monoammonium phosphate (MAP), di-ammonium phosphate (DAP), triple-superphosphate (TSP), struvite, or co-granulated struvite with MAP, DAP, or TSP and/or other nutrient/micronutrient components. The presence of the water treatment system in these embodiments can allow for more flexibility in the use of higher water volumes in the emission control scrubber systems, allowing easier operation, less scale formation and lower emission levels to atmosphere.

As another example, in some embodiments, phosphate processing system 100 provides re-use of sludges from any one or more of the process water treatment and/or precipitation stages that are high in phosphates (e.g., having a P₂O₅ content >5%, >10%, >15%, >20%, >25%, >30%, >35%, >40%, >45%, >50%) as substitute or supplement to phosphate rock input to a phosphoric acid manufacturing process. For example, phosphoric acid plant 110 can receive sludge from one or more of the systems shown in FIG. 2 (where present) and can use the sludge to produce phosphoric acid 112 and/or gypsum 118.

As another example, in some embodiments, phosphate processing system 100 uses a high magnesium phosphate rock (e.g., at 114) to produce a phosphoric acid product (e.g., phosphoric acid 112) with elevated magnesium product. This can allow production of a struvite fertilizer or a struvite and MAP/DAP/TSP cogranulated fertilizer in a granulation plant (e.g., granulation system 150) with a reduced need to add external/purchased magnesium source. In some embodiments, this has the double benefit of allowing the use of otherwise discarded or “lower grade” phosphate rock, while reducing or eliminating the cost of magnesium sources for the struvite component of the fertilizer produced. This can allow dedication of a phosphoric acid plant and granulation train for processing phosphate rock with elevated Mg content and producing a struvite fertilizer having struvite and MAP/DAP/DSP cogranulated into a fertilizer product. This process train could also take in or use struvite recovered from process water treatment, and/or from animal waste.

As another example, in some embodiments, phosphate processing system 100 uses acidity in pre-treated process water after precipitation (e.g., acidic solution 124) to acidify animal waste (e.g., poultry litter, hog manure, cattle manure) to solubilize phosphate contained in the animal waste. In some embodiments, this enables recovery of phosphate in a form suitable for use in a fertilizer. This can allow the animal waste to be used to raise the pH of the pre-treated process water instead of using purchased chemicals (e.g., limestone, lime, caustic soda) while the process water is used instead of purchased chemicals (e.g., sulfuric acid, phosphoric acid, hydrochloric acid) to acidify and strip the phosphate from the animal waste. The remainder of the plant (struvite crystallizer, granulator) can then be used to convert the stripped phosphate from the animal waste into fertilizer products, for example, at granulation system 150.

### Phosphoric Acid Plant

In some embodiments, phosphoric acid plant 110 produces phosphoric acid 112. Phosphoric acid plant 110 takes as input stream(s) one or more sources of phosphate, for example, an input stream may comprise phosphate rock 114 (e.g., high-grade phosphate rock, low-grade phosphate rock 116, and/or a combination of both) and/or a fluid 160 that contains phosphate (e.g., aqueous phosphate solution, pond water, process water, cooling water, slurry) or a processed fluid 160 (e.g., after concentration, dilution, other processing of fluid 160). As other examples, phosphoric acid plant 110 can use phosphate containing compounds such as calcium phosphate source or magnesium phosphate.

For example, phosphoric acid plant 110 can produce phosphoric acid 112 and gypsum (e.g., calcium sulfate) 118 by reacting sulfuric acid with a phosphate source.

In some embodiments, a phosphoric acid plant 110 is configured to use both a source containing levels of magnesium above a threshold amount (e.g., a source with high levels of magnesium), as well as a source containing levels of magnesium below a second threshold amount (e.g., a source with low levels of magnesium).

High-grade phosphate (e.g., in rock) can include a phosphorus-containing component such as phosphate (e.g., calcium phosphate) and, in some embodiments, a sulphur-containing component such as sulphate (e.g., calcium sulphate). For example, phosphoric acid plant 110 can receive high-grade phosphate rock or beneficiated phosphate rock ore having calcium phosphate or phosphate above a threshold amount (e.g., typically 27-39% P₂O₅ or >23% P₂O₅) and having impurities such as silica, fluoride, sulphates, carbonates (e.g., 1-3%), iron, aluminum (e.g., <5-6% iron and aluminum oxide combined) and magnesium (e.g., typical content trace to 3% MgO with most above 0.2% or 0.3% (e.g., 0.4-0.9% typical in Florida, 0.5% typical in Morocco, and up to 3% typical in Chinese rock), below a threshold amount (e.g., typically target below ˜5% Fe₂O₃, Al₂O₃ and MgO in total).

Low-grade phosphate (e.g., in rock) can include a phosphorus-containing component such as phosphorus (e.g., calcium phosphate), a magnesium-containing component, and/or one or more other species (e.g., iron, aluminum). In some embodiments, phosphoric acid plant 110 receives and/or uses low grade phosphate rock to produce phosphoric acid. The low grade phosphate rock can include magnesium above a threshold amount, for example with greater than 3% MgO.

Any magnesium in a low-grade phosphate composition (e.g., where a composition is a rock) may pose disadvantages for use in a phosphoric acid plant 110 to produce phosphoric acid because, for example, magnesium may cause the phosphoric acid plant 110 to become less efficient, cause build-up in various mechanical components, gum up machinery or plant equipment, increase viscosity of fluids, disadvantageously affect phosphoric acid production, disadvantageously affect granulation characteristics of ammoniated phosphate fertilizers made from the phosphoric acid, and/or undesirably affect one or more chemical reactions.

Magnesium impurity is typically considered to be undesirable in phosphate rock that may be used in phosphoric acid production. Accordingly, in some embodiments, phosphoric acid plant 110 typically maintains a ratio of MgO:P₂O₅ below 0.03 in the phosphoric acid (e.g., 112) produced from the phosphate rock or other phosphate-containing input (e.g., sludge 124) to minimize these operational issues, depending on equipment types and processing conditions.

However, production of struvite or other compounds that contain magnesium (e.g., at crystallizer system 130, at granulation system 150) requires magnesium. In some embodiments, low-grade phosphate (e.g., low-grade phosphate rock, phosphate source with magnesium impurity) is provided to phosphoric acid plant 110, along with sulfuric acid, and phosphoric acid plant 110 produces phosphoric acid 112, gypsum 118, and/or one or more other output streams 160 (e.g., aqueous phosphate solution such as pond water) which contain magnesium. These output streams may be supplied to crystallizer system 130 or granulation system 150 to supply some or all of the magnesium required for production of struvite, or struvite and MAP/DAP/TSP cogranulated fertilizer, or other desired magnesium-containing product.

In some embodiments, phosphoric acid plant 110 selects, receives, and/or uses low-grade phosphate containing 0.4-10% magnesium oxide (MgO). For example, phosphoric acid plant 110 may selectively mine layers of phosphate rock based on an amount of magnesium in the phosphate rock. For example, phosphate rock having magnesium above a threshold amount may be avoided.

As another example, phosphoric acid plant 110 may select ore having different amounts of magnesium and use a blend of same to produce an input source of phosphorus-rock having a collective amount of magnesium within a desired range. The phosphate rock can be used to produce phosphoric acid with elevated magnesium content and/or a magnesium-containing output. The magnesium-containing output can be provided to crystallizer 130 and/or granulation system 150 and used in production of struvite or struvite and MAP/DAP/TSP cogranulated fertilizer, or other materials containing magnesium, for example. This process can facilitate extension of the life of a body of phosphate rock as well as any environmental problems caused by abandoned heaps of low-grade phosphate rock, as well as reducing the requirement for imported/purchased magnesium containing materials/reagents such as magnesium oxide, magnesium chloride or magnesium sulphate, magnesium hydroxide, magnesium carbonate, or dolomitic lime for the production of the magnesium-containing products or struvite.

In some embodiments, one or more streams produced by phosphoric acid plant 110 is provided to granulator system 150, and granulator system 150 produces phosphate containing material (e.g., particles) such as struvite or struvite analogues. Use by granulator system 150 of one or more streams produced by phosphoric acid plant 110 from low-grade phosphate (e.g., low-grade phosphate rock) can reduce an amount of magnesium (and/or other material in some embodiments) required to be separately added to produce a desired product such as struvite or struvite analogues, in some embodiments. This may be because the one or more streams produced by phosphoric acid plant 110 contains magnesium (and/or other material in some embodiments) and instead of allowing such streams to become waste, granulator 150, in some embodiments, can use such streams to facilitate production of a desired product such as magnesium-containing struvite or struvite analogues. This can result in advantages in efficiency, cost, environmental impact, recycling, amount of substance(s) needed, and/or amount of pollutant(s) or polluted water produced, for example.

In some embodiments, phosphoric acid plant 110 receives one or more streams containing magnesium levels above threshold value(s), such as, high magnesium rock (e.g., low-grade phosphate rock). In some embodiments, phosphoric acid plant 110 uses same to produce phosphoric acid having a level of magnesium impurity above a threshold value and/or phosphoric acid at a concentration below a threshold value.

Phosphoric acid plant 110 can produce a phosphoric acid containing stream with one or more components at a concentration below a threshold value to help avoid or reduce scaling that may result from presence of an amount of magnesium that is higher than would normally be desired for phosphoric acid production alone. In some embodiments, phosphoric acid plant 110 provides one or more streams containing magnesium above a threshold value (e.g., a stream of phosphoric acid containing magnesium impurity) to granulation system 150. Granulation system 150 can then use same to produce one or more products, such as fertilizer 152 containing magnesium that may be advantageous for facilitating growth of crops and/or use of the fertilizer (e.g., nutrient release or uptake characteristics, pH, dissolution, other characteristic of the fertilizer). This may be advantageous for production of one or more products (e.g., by cogranulation), such as fertilizer 152. In some embodiments, lower concentration of phosphoric acid can effectively be used in the production of struvite based fertilizer in granulation plant 150 as compared to granulation of MAP/DAP, because the production of struvite fertilizers can absorb significant quantities of water from the phosphoric acid to form the crystal waters in the struvite. This feature can enable the operation of the phosphoric acid plant 110 at lower phosphoric acid concentrations, using less evaporator capacity, without negatively impacting the operation efficiency of the downstream granulation plant 150. For example, in some embodiments, phosphoric acid production (e.g., at phosphoric acid plant 110) can be operated at a concentration lower than 54% P₂O₅, or lower than 40% P₂O₅. In some embodiments, phosphoric acid production (e.g., at phosphoric acid plant 110) can be operated at a concentration lower than 52%, 50%, 48%, 46%, 44%, 42%, 38%, 35%, 30%, 25%, 20%, 15%, 10%, or 5%.

In some embodiments, phosphoric acid plant 110 can be unexpectedly used in this way to advantageously produce phosphoric acid using a phosphorous source containing magnesium above a threshold value (e.g., high magnesium rock). The presence of larger than usual amounts of magnesium in phosphoric acid plant 110 may reduce the efficiency of phosphoric acid plant 110. However, this may be more than offset by gains in efficiency and/or environmental benefits that arise when the magnesium is used in downstream processes. In some embodiments, phosphoric acid plant 110 produces phosphoric acid using a high magnesium source, and this can reduce production cost, as well as allow for use of otherwise unusable or uneconomic rock reserves and thereby mitigate or reduce environmental impacts of phosphoric acid production.

In some embodiments, phosphoric acid plant 110 can produce an output stream containing acid (e.g., phosphoric acid) and having 1% magnesium and provide same to granulation plant 150. This may be a significant amount for the purposes of granulation plant 150. For example, granulation plant 150 may produce an output stream having 3.5% of magnesium and may use the output stream from phosphoric acid plant 110 to produce same.

In some embodiments, a source with high levels of magnesium/phosphorous is used by granulation system 150 to produce struvite and/or is used in a chemical drying process, for example, as described in U.S. Pat. No. 9,334,166, entitled “METHODS AND COMPOSITIONS FOR CHEMICAL DRYING AND PRODUCING STRUVITE”, the entire contents of which is incorporated herein by reference, or used in cogranulation of struvite with MAP, DAP, and/or TSP, for example, as described in U.S. Pat. No. 9,878,960. In contrast, a high magnesium phosphoric acid source may tend to produce soft or sticky granulated material in other systems that produce ammonium phosphates (e.g., MAP/DAP) resulting in either off-specification product or operational challenges, as well as using a higher concentration of phosphoric acid (e.g., 54% P₂O₅ or similar) in the production of granular ammoniated phosphates due to a lack of the chemical drying feature of struvite production.

In some embodiments, granulation system 150 allows for co-granulation using a high magnesium phosphoric acid source from phosphoric acid plant 110 and this can provide additional options to expand exploitable mining resources for deposits that have elevated magnesium content.

In other phosphoric acid production processes, elevated magnesium levels can result in increased viscosity of the produced phosphoric acid, resulting in decreased operational efficiencies in filtering the phosphoric acid from the gypsum by-product, as well as resulting in increased scale formation and resulting maintenance in downstream evaporation processes and piping. In some embodiments, phosphate processing system 100, for example, at a phosphoric acid plant 110 can mitigate these issues by producing a more dilute phosphoric acid product (e.g., higher water content) (e.g., 112) than is optimal for granulation of ammoniated phosphates. In some embodiments, the dilute phosphoric acid product can more effectively be used in production of struvite containing fertilizer due to the crystal water absorbed by the product.

In some embodiments, the phosphoric acid plant 110 receives phosphate rock 114 that has been mined and/or processed, applies one or more processing steps, and outputs phosphoric acid 112. In some embodiments, phosphoric acid plant 110 can react ground phosphate rock (e.g., ground in a wet ball mill) with sulfuric acid in a phosphoric acid reactor, resulting in the production of phosphoric acid solution (e.g., 112) and gypsum precipitate (e.g., 118). In some embodiments, the mixture of phosphoric acid solution and gypsum is then filtered to separate the dilute phosphoric acid from the gypsum by-product, and the gypsum filter cake is then rinsed countercurrently with water (or more typically pond water/process water) to rinse as much phosphoric acid as practical from the gypsum by-product, for example, occurring at rinsing system 140. In some embodiments, the gypsum is then slurried in process water and pumped to a gypsum disposal site, for example, a gypsum stack system. In some embodiments, the phosphoric acid solution (e.g., 112) is then evaporated sequentially to produce a desired concentration of phosphoric acid for downstream granulation or other uses.

An example embodiment will now be described. In some embodiments, phosphorus-containing material, phosphate-containing material, phosphate rock, high-grade phosphate (e.g., high-grade phosphate rock), and/or low-grade phosphate (e.g., low-grade phosphate rock) is provided to phosphoric acid plant 110, and phosphoric acid plant 110 produces phosphoric acid 112, gypsum 118, and/or one or more other output streams 160 (e.g., aqueous phosphate solution such as pond water). This can facilitate production of phosphoric acid 112 (e.g., for use in fertilizer or in granulation), recycling of any residual phosphorus-containing material (e.g., that is attached to or associated with gypsum 118) or other residual material through filtering/rinsing system 140, and/or recycling of any residual phosphorus-containing material (e.g., in one or more output streams 160 such as any streams adding to pond water or an aqueous phosphate solution) or other material by precipitation system 120 and/or other processing (e.g., such as by concentration at 164, filtration, or other process described herein).

In some embodiments, phosphoric acid plant 110 produces one or more output streams that include gypsum 118. As an example, gypsum 118 includes calcium sulphate.

In some embodiments, an amount of phosphoric acid or other material is associated with (e.g., physically attached to) gypsum 118. A significant amount of phosphoric acid could be lost in this way. Rinsing the gypsum with fresh water is typically not considered practical because using fresh water for rinsing would contaminate the fresh water and can result in increased volumes of process water to be impounded and or treated and may be against environmental protection laws, and may result in increased dilution of the recovered phosphoric acid requiring further evaporative concentration downstream.

In some embodiments, phosphate processing system 100 at rinsing system 140 allows for rinsing of gypsum (e.g., gypsum 118 at rinsing system 140) in a way that is practical. This can be through re-use of the stream(s) rinsed and separated from gypsum. For example, in some embodiments, one or more output streams of system 100 are provided to gypsum rinsing system 140. For example, gypsum 118 and any phosphoric acid associated to gypsum 118 is provided to gypsum rinsing system 140, in some embodiments. After the gypsum is rinsed, the streams containing phosphoric acid rinsed from the gypsum may be returned to a point in system 100 where the phosphoric acid may be recovered and/or used. A significant amount of phosphoric acid may be recovered this way.

### Gypsum Rinsing System

In some embodiments, gypsum rinsing system 140 is configured to rinse an amount of gypsum (e.g., a composition containing gypsum 118) and collect an amount of phosphoric acid from same, using a rinsing fluid that is received from one or more other systems included in phosphate processing system 100 such as phosphoric acid plant 110. For example, the rinsing fluid, in some embodiments, is one or more output streams from phosphoric acid plant 110 and/or one or more streams from an aqueous phosphate solution, such as pond water. The rinsing fluid can contain an amount of one or more components below threshold value(s), where the component(s) and/or the threshold value(s) may be suitable for use by rinsing system 140, for example, to separate components.

In some embodiments, gypsum rinsing system 140 is configured to re-use water from one or more other systems of phosphate processing system 100 to adequately separate one or more components from a stream (e.g., an output stream). For example, in some embodiments, the stream includes gypsum and phosphoric acid, and gypsum rinsing system 140 applies a rinsing fluid (e.g., aqueous phosphate solution, pond water, output from one or more systems in phosphate processing system 100) to produce a stream containing phosphoric acid. For example, one or more processing steps can be applied to the stream and/or to any intermediate streams produced. In some embodiments, gypsum rinsing system 140 allows phosphoric acid to be salvaged from a waste stream containing gypsum 118. This can reduce the amount of phosphoric acid lost with the by-product gypsum sent to waste storage systems such as gypsum stacks.

In some embodiments, gypsum rinsing system 140 receives a slurry containing gypsum. The slurry can be produced by phosphoric acid plant 110 using sulfuric acid and phosphate rock during production of phosphoric acid, for example. For example, in some embodiments, gypsum rinsing system 140 receives a slurry containing gypsum and washes same with water to rinse phosphoric acid out. This process can leave residual phosphoric acid associated with the gypsum. The residual phosphoric acid can form a waste stream and/or be provided to rinsing system 140 for further processing (e.g., for collection of additional phosphoric acid such as all or a portion of the residual phosphoric acid). In some embodiments, gypsum rinsing system 140 applies one or more washing steps to an input stream (e.g., to a gypsum containing slurry). For example, gypsum rinsing system 140 can use pond water 160 as an initial rinsing fluid and clean water as a final rinsing fluid. This can facilitate reduction of impurities in a recovered product (e.g., a recovered acid) as compared to only applying rinsing fluid that is pond water 160. Gypsum rinsing system 140 may use pond water 160 as rinsing fluid in one or more steps (e.g., with the pond water 160 having different chemistry in one or more different steps) to mitigate water balance difficulties, for example, an addition of more fresh water to the phosphoric acid plant system than is lost to evaporation, resulting in accumulation of a volume of waste water/process water/pond water to be stored or treated.

### Pond Water

In some embodiments, pond water 160 (e.g., aqueous phosphate solution, phosphogypsum pond water, etc.) includes an amount of phosphate and/or phosphoric acid and/or phosphorus. Pond water 160 can be generated by one or more systems of phosphate processing system 100, for example, as outputs and/or waste products. Pond water 160 can be a sludge or slurry, for example. Pond water 160 may be the result of historical industrial operations. System 100 may process the pond water while recovering useful components from the pond water 160 such as struvite, MAP, phosphoric acid, gypsum, calcium fluoride, fluorosilicates, hydrofluoric acid, silicon hexafluoride, uranium, etc.

In some embodiments, pond water 160 is derived from one or more output streams from a phosphoric acid plant 110. For example, pond water 160 can be a phosphogypsum pond derived from a waste stream containing gypsum produced by phosphoric acid plant 110. For example, the waste stream can be formed from one or more input streams to phosphoric acid plant 110 (e.g., from an aqueous phosphate solution, pond water, phosphate rock 114, low grade phosphate rock 116, etc.).

In some embodiments, pond water system 160 is input to a treatment system 120 that receives and/or processes pond water 160. In some embodiments, pond water system 160 receives output streams from other parts of system 100 such as one or more output streams from exhaust treatment system 180 and/or from granulation system 150. For example, pond water system 160 can receive a sludge comprising a suspension of struvite particles and/or comprising fines that may be produced by granulation system 150 during a process for producing fertilizer 152 and/or by exhaust treatment system 180 following any collection of waste (e.g., hot gas containing struvite, fines, dust) from granulation system 150.

An example embodiment will now be described that can integrate pond water system 160 with exhaust treatment system 180 and, in some embodiments, granulation system 150. In some embodiments, exhaust treatment system 180 captures, scrubs, collects, thickens, isolates, and/or otherwise processes fines, exhaust gasses and dust that comprise useful materials such as struvite, ammonium phosphates, other materials containing phosphate, magnesium and/or ammonium etc. flowing in a gas (e.g., an airflow system directing one or more output streams from one or more systems of phosphate processing system 100. For example exhaust treatment system 180, may collect exhaust gasses, fine powders and dust using suction fans to draw contaminated air from the various processes in a granulation plant (e.g., 150) (granulation drum, dryer, cooler, screening, conveyors, storage bins, grinders, feed tanks or hoppers, etc.) using exhaust fans, and direct the contaminated air to air pollution equipment to separate solids particles from the air (e.g., cyclones, filters, baghouses, scrubbers), or to removed exhaust gasses from the air (e.g., scrubbers, condensers, etc.).

In some embodiments, exhaust treatment system 180 includes an air pollution control process which collects dry powders from the air stream which can be directly reused in the granulation process. In other cases, wet scrubbers, collect and concentrate exhaust gasses like ammonia and fine dusts into the scrubber fluid which can become a slurry. In some embodiments, the slurry may require periodic blowdown, and replenishment with fresh liquid (e.g., can be usually water and/or an acid such as phosphoric acid, sulfuric acid, or a base such as sodium hydroxide). The scrubber slurry blowdown stream can either be directly reused in the granulation process (e.g., at granulation system 150) if the water balance allows, or must be disposed of and/or treated, for example, sent to the pond water system 160 for disposal or advantageously be treated in a stage of a pond water treatment system 160 that can capture, concentrate and/or recover the desirable components of the scrubber slurry blowdown and return them to the granulation process (e.g., at granulation system 150) in a more desirable form. For example, the scrubber blowdown slurry can be sent to a struvite fines clarifier to settle and concentrate the fine struvite dust particles from a struvite granulation or cogranulation plant (e.g., 150), where the settled solids can be dewatered and returned to the granulation plant for reuse. The soluble phosphates, ammonia or ammonium phosphate dust can be returned to a pond water treatment system (e.g., 160) for recovery of the ammonia and phosphate components as struvite. In some embodiments, the blowdown stream is minimal in flow, but high in concentration and this can allow the blowdown stream to have minimal impact on the design/capacity of the pond water treatment system (e.g., 160), but can be used to recover economically meaningful amounts of the components in the blowdown, and to provide clean water back to the scrubber system at relatively high volumes. This can enable better scrubbing of the exhaust gasses from the granulation plant and lower emissions to the environment.

Pond water system 120 can facilitate reuse of particles (e.g., struvite); decrease waste produced from one or more systems of phosphate processing system 100; and/or reduce an amount of material used in one or more steps and/or processes of one or more systems in phosphate production system 100.

In some embodiments, pond water 160 is reused by one or more systems of phosphate processing system 100. In some embodiments, pond water 160 is reused by phosphoric acid plant 110.

For example, in some embodiments, use of pond water 160 facilitates re-cycling, re-use, and/or salvaging of one or more components, for example, components that may otherwise be produced as an output stream from one or more systems of phosphate processing system 100 and/or discarded as waste. Pond water 160 can mitigate negative environmental impacts, for example. For example, phosphoric acid plant 110 may produce a waste output stream that contains phosphoric acid below a threshold amount (e.g., below an amount that may be used by granulation system 150 and/or in production of fertilizer 152).

Pond water 160 can receive a waste output stream from phosphoric acid plant 110. Pond water 160 can produce and/or be directed as an input stream to precipitation system 120 for precipitation of calcium phosphate using the phosphoric acid contained in the waste stream, for example.

In some embodiments, pond water 160 is received by precipitation system 120 and precipitation system 120 causes precipitation of one or more components and forms a sludge 124 or slurry 124. The sludge 124 or slurry 124 can be comprised of one or more precipitated components suspended in solution, for example. In some embodiments, sludge 124 is provided to phosphoric acid plant 110 and one or more precipitated components are used by phosphoric acid plant 110 to produce phosphoric acid.

In some embodiments, an input stream derived from pond water 160 can be provided to phosphoric acid plant 110 to produce higher grade phosphoric acid (e.g., lower impurity phosphoric acid). For example, this can occur in cases where some or one of the sludges produced from treating pond water contains phosphates and lower concentrations of impurities than the phosphate rock being processed by phopsphoric acid plant 110. In this case it is possible to more cost effectively produce higher purity phosphoric acids, for example for food or industrial chemical grade products.

In some embodiments, slurry and/or sludge precipitated from pond water 160 can contain elevated levels of phosphate (i.e. >10% P2O5) and can form an input stream to the phosphoric acid plant 110. In some embodiments, phosphoric acid plant 110 receives a slurry or sludge, for example, a high phosphate sludge as a substitute or as a supplement to phosphate rock.

In some embodiments, one or more streams from one or more systems included in a phosphate processing system 100 is concentrated, for example, at 164. This can facilitate reduction of cost of hauling pond water to treatment/storage sites. In some embodiments, pond water system 160 concentrates residual pond water if concentrations of one or more components in the pond water decrease over time (e.g., years). Concentration using nanofiltration or reverse osmosis can be used to produce a concentrate stream and a clean water permeate stream that could be discharged to the receiving environment or reused for other purposes such as rinsing gypsum (e.g., at rinsing system 140).

In some embodiments, pond water system 160 concentrates a stream for one or more components using nanofiltration and/or reverse osmosis. In some embodiments, one or more output streams following a nanofiltration and/or reverse osmosis process is provided at 162 to precipitation system 120. In some embodiments, performance of a nanofiltration process and/or a reverse osmosis process is based on charge balance and/or solubility (e.g., reverse osmosis to a lesser extent than nanofiltration process).

In some embodiments, pond water 160 (e.g., a phosphogypsum pond) and/or processed pond water 160 (e.g., concentrated stream 164) is provided to one or more input streams of precipitation system 120. For example, pond water 160 from sites remote from phosphate processing system 100 may be concentrated by processes that may involve collecting the concentrate from a membrane filtration system. The concentrated pond water may then be transported to the location of system 100 and used as an input stream to one or more sub-systems of system 100.

### Precipitation System

In some embodiments, precipitation system 120 receives one or more input streams such as a fluid 160 (e.g., aqueous phosphate solution, pond water, slurry). The fluid 160 can be phosphogypsum pond water generated by a phosphoric acid plant 110, for example. As another example, fluid 160 can be a concentrated stream 164 or a stream derived from processing pond water 160.

In some embodiments, precipitation system 120 produces one or more precipitants, for example, from one or more input streams. In some embodiments, the one or more input streams are derived from one or more output streams of one or more systems of phosphate processing system 100. The one or more precipitants can form one or more output streams of precipitation system 120, for example, that are used to derive one or more inputs to one or more systems of phosphate processing system 100, in some embodiments. For example, one or more output streams (e.g., containing precipitant(s)) can be provided by precipitation system 120 to a phosphoric acid plant 110, for example, as including a sludge 124, gypsum 126, and/or fluoride-containing component(s) 128 or fluorosilicates (see, for example, U.S. patent application Ser. No. 14/240,701, published as U.S. Publication No. 2014/0231359, entitled “TREATMENT OF PHOSPHATE-CONTAINING WASTEWATER WITH FLUOROSILICATE AND PHOSPHATE RECOVERY”, the entire contents of which are herein incorporated by reference).

In some embodiments, precipitation system 120 receives one or more input streams such as a fluid 160 (e.g., aqueous phosphate solution, pond water, slurry). The fluid 160 can be phosphogypsum pond water generated by a phosphoric acid plant 110, for example. As another example, fluid 160 can be a concentrated stream 164 or a stream derived from processing pond water 160.

In some embodiments, precipitation system 120 adds bases (limestone, lime, caustic, ammonia etc.) to raise the pH of pond water and this can result in sequential precipitation of components of the pond water including silica, fluorides, phosphates, calcium, and trace metals, including heavy metals. This is described, for example, in U.S. patent application Ser. No. 13/698,129 (U.S. Pat. No. 10,196,289, entitled “TREATMENT OF PHOSPHATE-CONTAINING WASTEWATER”), the entire contents of which is herein incorporated by reference, and U.S. patent application Ser. No. 14/240,701 (U.S. Publication No. 2014/0231359). Some of the precipitated solids (e.g., sludges produced as described in U.S. Pat. No. 10,196,289 and U.S. Publication No. 2014/0231359) can contain high levels of phosphate compounds, particularly calcium phosphate and/or struvite, and low levels of impurities such as heavy metals or radioactive components, which can be settled, dewatered, or otherwise concentrated and subsequently reused in the phosphoric acid plant 110 as a substitute for phosphate rock. This can provide improvements in efficiency, environmental impact, and cost, for example, by allowing re-use of waste stream(s) 160 (e.g., pond water, aqueous phosphate solution, etc.) following precipitation of components to produce one or more output streams with a desired composition (e.g., a stream with a greater concentration or amount per volume of certain type(s) of precipitant than in an input stream of the precipitation system 120; a stream with a lesser concentration or amount per volume of certain type(s) components such as those that may have formed precipitant(s); etc.) Specifically, sludge or precipitated solids that may be produced as a by-product from a system of phosphate processing system 100 or from a system described in U.S. patent Ser. No. 10/196,289 and U.S. Publication No. 2014/0231359 can be used in phosphoric acid plant 110 as a substitute for phosphate rock, for example, to produce phosphoric acid 112.

In some embodiments, precipitation system 120 produces one or more precipitants, for example, from one or more input streams. In some embodiments, the one or more input streams are derived from one or more output streams of one or more systems of phosphate processing system 100. The one or more precipitants can form one or more output streams of precipitation system 120, for example, that are used to derive one or more inputs to one or more systems of phosphate processing system 100, in some embodiments. For example, one or more output streams (e.g., containing precipitant(s)) can be provided by precipitation system 120 to a phosphoric acid plant 110, for example, as including a sludge 124, gypsum 126, and/or fluoride-containing component(s) 128 or fluorosilicates (see, for example, U.S. patent application Ser. No. 14/240,701, published as U.S. Publication No. 2014/0231359, entitled “TREATMENT OF PHOSPHATE-CONTAINING WASTEWATER WITH FLUOROSILICATE AND PHOSPHATE RECOVERY”, the entire contents of which are herein incorporated by reference).

In some embodiments, precipitation system 120 processes one or more input streams to produce one or more precipitants and/or one or more effluent streams 122. For example, precipitation system 120 can add bases (e.g., from limestone, lime, ammonia, caustic, etc.) to one or more of the input stream(s) to produce a slurry. As another example, precipitation system 120 can add brine (e.g., a concentrated salt solution) and/or another solution to one or more of the input stream(s) to increase the pH past a threshold level to produce (e.g., precipitate) calcium phosphate and/or gypsum. As another example, precipitation system 120 can add a solution or material to one or more of the input stream(s) and decrease or increase the pH past a threshold level to produce one or more streams. These one or more streams can be used as an input stream in a precipitation process, for example.

In some embodiments, precipitation system 120 produces an effluent stream 122 by precipitating one or more precipitants (e.g., calcium fluoride, fluorosilicates, calcium phosphate, gypsum, silica polymers, precipitants in a slurry) from one or more input fluid streams in one or more precipitation steps.

For example, precipitation system 120 can precipitate one or more precipitants in an input fluid stream and separate one or more of those precipitant(s) from the input fluid stream to produce an effluent stream 122. The separation can be by filtration, settling, osmosis, selective binding of components, and/or one or more reactions, for example. One or more effluent streams 122 can include a reduced concentration and/or altered composition of components compared to one or more of one or more input fluid streams. For example, precipitation system 120 can produce an effluent stream 122 containing reduced amounts or concentrations of phosphate ions and calcium ions; a precipitant stream containing precipitated calcium phosphate; and/or an acidic output stream 124 (e.g., containing phosphoric acid).

In some embodiments, precipitation system 120 produces sludge output stream(s) 124, gypsum output stream(s) 126, and/or fluoride output stream(s) 128. These can include calcium phosphate precipitates with concentrations of P₂O₅ exceeding 10% (in some embodiments, exceeding 15%, 20%, 25%, 30%, 35%, 40%, 45%, 50%, 55%, 60%, 65%, 70%, 75%, 80%, 85%, 90%, or 95%), calcium fluoride precipitates, and/or fluorosilicate precipitates (for example, sodium fluorosilicate).

In some embodiments, one or more output streams from precipitation system 120 are provided to rinsing system 140 or crystallizer system 130.

### Crystallizer System

In some embodiments, crystallizer system 130 causes crystallization of one or more components received from one or more output streams produced by phosphate processing system 100. For example, in some embodiments, crystallizer system 130 can receive one or more effluent streams 122 such as from precipitation system 120. The one or more effluent streams 122 may be produced after one or more components have been precipitated in solution by precipitation system 120. In some embodiments, one or more other components are added to the one or more effluent streams 122 and same is then processed by crystallizer 130. The components added can facilitate or improve crystallization, for example.

In some embodiments, crystallizer 130 receives one or more streams (e.g., from one or more systems of phosphate processing system 100 or such streams after processing) and causes crystallization of one or more components in the one or more streams. For example, in some embodiments, crystallizer 130 receives a stream of phosphorus-containing material (e.g., effluent 122 from precipitation system 120, phosphate-containing stream from organics removal system 170, phosphoric acid-containing stream from rinsing system 140 and/or phosphoric acid plant 110), processes such stream, and causes struvite crystallization or precipitation. In some embodiments, the stream is processed by addition of one or more components, for example, seeds (e.g., small crystalline material) to facilitate crystallization, acid and/or base to adjust pH, a magnesium or ammonia or phosphate source, and/or catalyst(s).

In some embodiments, one or more components are added to crystallizer 130 to improve or facilitate or impact crystallization and can be derived from one or more other streams from a system included in phosphate processing system 100. For example, precipitation system 120, phosphoric acid plant 110, rinsing system 140, granulation plant 150, or exhaust treatment system 180, and/or other systems may produce one or more streams from organic material such as animal manure or poultry litter and/or other components. In some embodiments, the one or more streams are processed, for example, diluted for one or more components, concentrated for one or more components, precipitated for one or more components, has its pH adjusted, has its temperature adjusted, and/or has one or more components added, removed, increased, and/or reduced. For example, one or more streams containing organic phosphate containing material 172 (e.g., manure) is combined with one or more streams from precipitation system 120 (e.g., one or more output streams that is an acidic solution 124) and is processed by an organics removal system 170. In some embodiments, organics removal system 170 modifies, reduces, removes, and/or increases an amount of one or more organic-related material from one or more streams. For example, organics removal system 170 can remove an amount of organic material in one or more streams that may be formed from an output stream of precipitation system 120 and manure (e.g., organic phosphate containing material).

In some embodiments, crystallizer 130 receives fines from a granulation system 150 and/or exhaust treatment 180.

### Cogranulation System

In some embodiments, granulation system 150 receives P, N, and Mg, for example, as phosphoric acid, ammonia, and MgO and produces co-granulated (e.g., homogenous granules) compositions such as struvite-containing fertilizer. For example, in some embodiments, granulation system 150 receives phosphoric acid (e.g., from phosphoric acid plant 110), struvite from crystallizing system 130 or dewatering system 184, and/or struvite and/or phosphate and ammonium phosphate compounds from exhaust treatment system 180. In some embodiments, granulation system 150 also receives other components from one or more streams produced by one or more systems of phosphate processing system 100.

In some embodiments, granulation system 150 processes and/or granulates these components and produces fertilizer 152. For example, in some embodiments, granulation system 150 can granulate phosphoric acid 112 from phosphoric acid plant 110, struvite from crystallizer 130 (e.g., struvite produced from crystallizer 130 and/or struvite concentrated or dewatered from exhaust fines from exhaust system 180), and magnesium-containing product produced by phosphoric acid plant 110 from a magnesium-containing phosphate source (e.g., low grade phosphate rock 116). Granulation system 150 can then produce fertilizer 152 from such granulation, for example. Granulation system 150 can produce, for example, struvite based fertilizers using a chemical drying process, or cogranulated struvite products with water soluble phosphates sources such as MAP/DAP/TSP, optionally with additional nutrients or micronutrients.

In some embodiments, granulation system 150 produces exhaust, for example, struvite particles contained in a gas or hot gas. In some embodiments, granulation system 150 provides exhaust to exhaust treatment system 180. In some embodiments, exhaust treatment system 180 extracts and/or separates fertilizer particles from any exhaust received. For example, exhaust treatment system 180 can wash the exhaust using an output stream from one or more systems of phosphate processing system 100, such as pond water 160 or solution containing one or more types of particles (e.g., struvite) in amount(s) below threshold value(s). This can facilitate recycling of water, increased capture or yield of one or more components (e.g., struvite, phosphate, ammonia), and/or provide environmental amelioration.

In some embodiments, exhaust treatment system 180 produces fines 182, which can contain an altered composition of components as compared to one or more input streams to exhaust treatment system 180. For example, fines 182 can be a composition with an increased amount per volume of struvite particles. In some embodiments, fines 182 are provided to a dewatering system 184 for further processing. For example, dewatering system 184 can dewater the fines and produce a dry composition of struvite particles. One or more output streams from dewatering system 184 can be provided to one or more systems in phosphate processing system 100, for example, combined with one or more output streams from crystallizer 130, such as, phosphate containing particles 132. This can facilitate recapture or increased yield of one or more types of particles from one or more different systems in phosphate processing system 100. For example, one or more streams can be combined from different systems to produce a composition with an increased amount per volume (e.g., increased concentration) of one or more components. This can facilitate further processing, such as, detection, measurement, and/or reuse of the one or more components, as they may be in an amount above a threshold value that may facilitate or permit such detection, measurement, and/or reuse, for example, in granulation system 150.

For example, in some embodiments, fines 182 dewatered at dewatering system 184 can be combined with any struvite particles 132 produced by crystallizer 130 and provided to pug mill 186 (or other mixing device) for processing in granulation plant 150, or sent directly to granulation plant 150 for incorporation into granulated fertilizers. In some embodiments, pug mill 186 provides one or more processed output streams to granulation system 150. This can facilitate salvaging of one or more components (e.g., phosphate-containing particles) for re-use by granulation system 150 to produce fertilizer 152, for example.

In some embodiments, a scrubber water blowdown process (e.g., a scrubber liquid purge) is implemented by phosphate processing system 100. For example, scrubber liquid can be concentrated over time as more solids are added to the scrubber, and the liquid may be purged from the scrubber every once in a while (or continuously) to maintain a reasonable solids concentration in the scrubber. The scrubber efficiency (capability to remove particulate, etc.) can be impacted by the solids concentration.

In some embodiments, dewatering system 184 applies a dewatering step to a scrubber water blowdown process and facilitates recovery of a slurry of dust or solids or fines (e.g., struvite dust, fertilizer dust or the like) that may be captured in a scrubber. This can facilitate concentration or re-concentration with respect to one or more components or dust or solid or fine particles (e.g., struvite) and facilitate provision of a concentrated stream to granulation system 150. Granulation system 150 can thereby use recycled or recollected dust or solid or fine particles and reduce an amount of one or more components that may be added during one or more granulation steps, for example, steps in producing fertilizer 152. This process can also facilitate reduction of a water load on one or more granulators and reduction of energy that may be used in a drying process, for example.

In some embodiments, granulation system 150 receives, uses, and/or adds sulfur (e.g., elemental sulfur), sulfate, zinc, boron, and/or one or more other components. For example, one or more components can be cogranulated with struvite or a phosphorus-containing component to produce fertilizer 152. As another example, micronutrients and/or macronutrients can be cogranulated with one or more other components, such as phosphate-containing components (e.g., struvite, dittmarite, MAP/DAP/TSP). In some embodiments, granulation system 150 produces composition(s) with different release rates with respect to each other and/or with respect to one or more constituent components in each composition. For example, granulation system 150 can produce a fertilizer with fast and slow release phosphate, with the phosphate being a component in different constituent species and/or arranged or dispersed or granulated in a particular way. In some embodiments, granulation system 150 uses one or more components that are received and/or derived from one or more input streams from one or more systems included in a phosphate processing system 100.

In some embodiments, granulation system 150 is integrated with pond water system 160. For example, a struvite granulation/cogranulation facility 150 can be integrated with a pond water treatment process. This can provide various advantages. For example, in some embodiments, granulation system 150 generates a slurry of captured struvite fertilizer dust in water or acidic solution and returns same to pond water system 160. Pond water system 160 can then use same in a struvite recovery step in a phosphogypsum treatment process. For example, pond water system 160 can produce and/or isolate struvite, phosphorus-containing material, phosphoric acid, gypsum, magnesium, fluoride, calcium phosphate, calcium-containing material, sulphuric acid, and/or other component in one or more streams. This can facilitate reduction of and/or debottlenecking of any evaporative capacity of a granulator.

For example, in some embodiments, a slurry that may otherwise be sent to a granulator 150 can instead be sent to pond water system 160 and pond water system 160 can treat the slurry. Pond water system 160 can accommodate flow from air pollution control equipment and capture and thicken struvite fines from wastewater, for example. In some embodiments, wet struvite dust or powder is incorporated into a product at granulation system 150. Integration of granulation system 150 with pond water system 160 can provide advantages such as mitigation of environmental impact, improved yield of one or more components, reduction in use of any additional amount of one or more components, facilitation of recycling and/or reuse of one or more components, production of one or more streams (e.g., compositions) with desirable amounts, ratios, states, and/or compositions of one or more components. For example, capture of magnesium in a waste stream can facilitate production of struvite fertilizer having magnesium.

In some embodiments, granulation system 150 receives one or more streams from phosphoric acid plant 110 that contain magnesium above threshold amount(s). The one or more streams may be produced by phosphoric acid plant 110 from a source containing magnesium above a second threshold amount (e.g., a phosphate rock containing high levels of magnesium impurity). In this way, phosphoric acid plant 110 can help reduce an amount of magnesium from another source that may be added to produce a product such as fertilizer.

In some embodiments, granulation system 150 heats and/or cools reaction intermediates in one or more processing (e.g., granulation) steps. In some embodiments, granulation system 150 selects the temperature based on one or more intermediates, desired product(s), desired form(s), desired treatment step(s), or other reaction characteristic. For example, granulation system 150 may increase the temperature of a reaction above a threshold amount (e.g., above an amount that may be used in a process to make a different fertilizer) and the increased temperature may facilitate production of the product and/or facilitate drying of one or more intermediate(s) and/or product(s). This can allow for absorption of water, for example. Heat may also affect an amount of power used by granulation system 150. Temperature selection can advantageously mitigate cost and/or environmental impact. For example the granulation plant 150 may be operated to keep the components below a temperature of about 55° C. or 60° C. to produce a struvite based fertilizer or operated at a temperature above 60° C. (e.g., above 65° C., 70° C., 75° C., 80° C., 85° C., 90° C., and so on) to produce a dittmarite based fertilizer.

### Sludge

In some embodiments, a sludge or slurry is produced by phosphate processing system 100. For example, in some embodiments sludge 124 is produced from pond water system 160. As another example, in some embodiments, sludge 124 is produced by precipitation system 120 (e.g., as one or more precipitated components suspended in solution), by organics removal system 170, by a step or system included in phosphate processing system 100, and/or one or more output streams from any one or more of same.

In some embodiments, sludge (e.g., sludge produced by a system included in phosphate processing system 100) is reused. For example, treatment sludges from the phosphogypsum pond water treatment technology can be reused as a source of calcium phosphate to substitute for virgin phosphate rock in phosphoric acid plant 110.

For example, in some embodiments, input to phosphoric acid plant 110 can include a sludge composition (e.g., sludge from calcium phosphate precipitation stages of a phosphogypsum pond water treatment) that resembles the composition of phosphate rock (e.g., calcium phosphate with an amount of Si/F impurities). In some embodiments, phosphoric acid plant 110 reuses the sludge to produce phosphoric acid. In some embodiments, sludge is incorporated in a phosphoric acid production step. The phosphoric acid can be used for a granulation step 150 on site. This can provide advantages when installed at an operating phosphoric acid complex or at a shutdown site where existing abandoned phosphoric acid production systems can be repurposed, for example.

In some embodiments, sludge is reused directly at an existing phosphoric acid production site, incorporated as a phosphoric acid production step, and used to produce phosphoric acid to integrate with chemical drying granulation (for example, see U.S. Pat. No. 9,334,166), or integrated with co-granulation technologies (for example, see U.S. Pat. No. 9,878,960), or in the production of granular phosphate fertilizers such as MAP/DAP/TSP in a granulation step on site or at another location. This can be particularly attractive when installed at an operating phosphoric acid complex or at a shutdown site where existing abandoned phosphoric acid production and granulation assets can be repurposed, for example.

In some embodiments, a sludge and/or slurry is produced by granulation system 150. For example, in some embodiments, a treatment system 180 (e.g., air pollution control system, exhaust treatment) generates a slurry of captured fertilizer dust in water or acidic solution. This may be generated from one or more output streams from granulation system 150, for example, one or more waste output streams.

In some embodiments, the slurry is provided to a struvite recovery step in a phosphogypsum pond water treatment system 160. This can provide several advantages, for example, reducing or debottlenecking any evaporative capacity of granulation system 150 (e.g., a granulation plant). For example, the slurry can be reused by and/or incorporated in pond water 160 for re-use in one or more systems in phosphate processing system 100, for example, to crystalize struvite and/or other components at crystallizer 130 or to precipitate struvite and/or one or more other components at precipitation system 120, according to some embodiments. In some embodiments, a struvite granulation/cogranulation facility 150 is integrated with a pond water treatment process 160.

In some embodiments, pond water treatment system 160 includes a step for capturing and/or thickening fines (e.g., struvite fines, fines 182) from one or more output streams (e.g., wastewater, an output stream from granulation system 150, an output stream from exhaust treatment system 180). In some embodiments, pond water treatment system 160 can easily accommodate flow from air pollution control equipment (e.g., air pollution treatment system 180).

As another example, in some embodiments, a slurry (e.g., produced by granulation system 150 and/or by exhaust treatment system 180) is provided to granulation system 150 and the slurry (e.g., wet struvite or fertilizer dust) is incorporated (directly or indirectly) into a product produced by granulation system 150. This can facilitate increasing the yield of product, for example, of struvite or fertilizer-containing product per amount of struvite or fertilizer that may be inputted into the system. For example, this may decrease an amount of struvite or fertilizer lost (e.g., not incorporated into product) by granulation system 150 such as by allowing for capture and/or reuse of struvite or fertilizer in dust, waste, particulate, suspended, sludge, and/or slurry form. In some embodiments, sludge/slurry (e.g., containing struvite or fertilizer particles) may be provided to one or more systems of phosphate processing system 100 for processing (e.g., precipitation by precipitation system 120, crystallization as struvite in crystallizer 130 concentration at concentration system 164, etc.) and one or more resulting streams can be provided to granulation system 150.

In some embodiments, sludge from pond water treatment system 160 or precipitation system 120 is used to produce technical grade or food grade phosphoric acid, for example, at a phosphate processing system 100 that can include integrated mining/fertilizer/phosphogypsum/technical and/or food grade acid processes. In some embodiments, one or more processing steps are applied to sludge to produce one or more components. Such components can be separated or mixed, for example. Such components may be used by one or more systems included in a phosphate processing system 100. For example, in some embodiments, phosphoric acid plant 110 receives sludge with lower impurities than phosphate rock to produce phosphoric acid with lower impurities.

In some embodiments, precipitation process 120 produces calcium fluoride. For example, precipitation process 120 can produce calcium fluoride where calcium fluoride is in an amount above a threshold value (e.g., at a concentration above a threshold value) and/or having one or more specific characteristics (e.g., at a purity above a threshold value). This can facilitate production, collection, and/or re-use of calcium fluoride from a waste stream produced by precipitation process 120, for example.

In some embodiments, precipitation system 120 produces a sodium fluorosilicate sludge. Sodium fluorosilicate can be a source of fluoride and can be used in drinking water treatment or as a source of silica, for example, for solar panel manufacture. Production of this sludge can provide advantages, for example, facilitation of fluoride production removal of silica from the pond water to be treated, reducing potential for silica jel formation, mitigation of environmental impact, and/or improved product yield and/or purity. For example, this sludge can be used to produce and/or isolate sodium fluorosilicate having 98%, 96-99%, above 90%, above 80%, above 70%, above 60%, and/or above 50% purity. In some embodiments, precipitation system 120 provides phosphate and fluorosilicate recovery, for example, using U.S. application Ser. No. 14/240,701 (U.S. Publication No. 2014/0231359).

In some embodiments, one or more systems included in a phosphate processing system 100 produces calcium fluoride (e.g., in a sludge stream) and, in some embodiments, optimizes production of stream(s) containing same (e.g., optimizes amount, composition of the stream(s), form, pH, location of production, chemistry). For example, in some embodiments, the one or more systems (e.g., precipitation system 120) produces calcium fluoride. This can facilitate re-use of sludge containing calcium fluoride.

In some embodiments, sludge streams from precipitation system 120 with elevated calcium phosphate content are provided back into ball mills and/or provided directly to phosphoric acid reactors 110, for example, where water balance is at a threshold value (e.g., within a threshold range between various systems included in phosphate processing system 100). This can help reduce the volume of sludge to be disposed of from pond water treatment system 160 or precipitation system 120. For example, sludge with high calcium phosphate can be processed in ball mills along with phosphate rock and in turn fed to, phosphoric acid reactor 110 to produce phosphoric acid.

In some embodiments heat generated in system 100 is applied to remove water from struvite to yield dittmarite and the dittmarite is input to a granulation system to make fertilizer. Using dittmarite instead of struvite can result in a fertilizer that has a higher nutrient content per unit of weight.

An example phosphate processing system 100 according to some embodiments will now be described.

In this embodiment, phosphate processing system 100 integrates input and output streams from various systems included in phosphate processing system 100. For example, such streams using treated pond water from pond water treatment system 160 include cooling water tower makeup/blowdown, vacuum pump seal water inlet/outlet, as well as various streams listed below. In various embodiments, one or more streams may be omitted. Unless otherwise specified, the following values are in relation to an approximate 1,000 TPD P₂O₅ processing rate and are expressed as gallons per minute of water as a function of P₂O₅ production. Various water-using streams included in phosphate processing system 100 will now be described. Various values are specified and can be varied as such in the same embodiment or in different embodiments.

### Sulfuric Acid

Fresh water can be made up into sulfuric acid towers: (In) 65 GPM or 80 GPM (e.g., a sulfuric plant, with HRS). A heat recovery system may change the amount of dilution water.

There can be a cooling tower feed: (In) 2800 TPD H₂SO₄ for 1,000 TPD P₂O₅: 1,231 GPM=Total In

There can be a cooling tower blowdown: (Out) minus Drift=822.542 GPM; Blowdown=408.473 GPM at 3 cycles of concentration. Drift plus blowdown equals total flow In. Blowdown equals the total flow In divided by the cycles of concentration.

Boiler make up: Minor stream, for facilities with condensate recovery systems. This is optionally included.

### Phosphoric Acid

There can be water provided to ball mills: (In) Total in slurry 261.2 GPM. Incoming water in rock can be 83.2 GPM. There may be 178 GPM water to ball mills.

There can be a reactor barometric condenser: (In/out) 3054 GPM In/2652 Out. Much of the primary “Out” can be reused in a cloth wash.

There can be water evaporated from a reactor: (Out) 15.78 GPM (if considered separately from a barometric water stream)

There can be reactor scrubber water flow: (In/out) 485 GPM

There can be reactor vacuum pump seal water: (In) 30 GPM. This is omitted from some embodiments of phosphate processing system 100.

There can be cake wash water to filter gypsum filters: (In) 667 GPM

There can be cloth wash and sluice water provided to a slurry stream and in gypsum transport: (Out) 556 GPM (Cloth Wash). 1618.2 GPM (Sluice Water).

There can be filter pan freshwater sprays: (In) De Minimis volume from very fine sprays.

There can be filter table vacuum pump seal water: (In) 20 GPM

There can be an evaporator barometric condenser supply: (In/Out) 12,758.5 GPM (In); 12,990.9 GPM (Out)

There can be water evaporated from evaporators: (Out) 1000 TPD*(1/0.28)−(1/0.52)=1648 tons=274.5 GPM (if considered separately from the barometric water stream).

There can be fluorosalicic acid makeup water that can be a minor stream. This is omitted from some embodiments of phosphate processing system 100.

### Granulation

There can be pond water scrubbers: (In/out) Pond water flow to downstream systems and tail gas scrubbers can be 1,320 GPM (In) and 1,350 GPM (Out). Granulation system 150 is a negative user in some embodiments.

There can be freshwater/closed loop scrubbing systems: (In) 10-20 GPM. For example, there may be approximately 10 feet per second velocity and 55 GPM maximum flow.

### Phospho-Gypsum System

In some embodiments, in operating plants (e.g., phosphoric acid plant 110) with a normal heat load, rainfall over time equals evaporation. When plants are shut down and heat load is lost, the balance may change towards accumulating excess water.

There can be various wash water streams: This can be a minor stream. This is optional in some embodiments.

There can be packing and seal water streams: This can be a minor stream. This is optional in some embodiments.

There can be potable/septic water streams: This can be a minor stream. This is optional in some embodiments.

There can be evaporation/condensation other than rain and cooling ponds: This can be minor streams. This is optional in some embodiments.

In some embodiments, various streams are inputs and/or outputs between various systems included in the phosphoric acid plant 110 as described in the following example.

WATER BALANCE FOR GYPSUM & COOLING PONDS

| WATER IN | GPM |
|---|---|
| Evaporator condensers | 10,632 |
| Vac. Cooler prim. Condenser | 525 |
| Vac. Cooler sec. Condenser | 2,529 |
| Fume Scrubber | 404 |
| Vac. Pump & filter scrubbers | 333 |
| Rock grinding | 26 |
| Water stays in gyp pond | 276 |
| From steam condensation | 44 |
| TOTAL IN | 15,005 |
| WATER TO WATER SUMP | |
| Evaporator condensers | 10,825 |
| Vac. Cooler sec. condenser | 2,652 |
| Steam condensate | 44 |
| Filter scrubbers (assumed) | 333 |
| Fume scrubber | 431 |
| TOTAL WATER TO WATER SUMP | 14,285 |
| Water to cake wash (assumed) | 666 |
| Water to cloth wash (assumed) | 556 |
| Water to sluice | 1,618 |
| SUB TOTAL ABOVE 3 ITEMS | 2,840 |
| WATER OUT | |
| Water to cooling pond = (Total water | 12,001 |
| to water sump) − (water to cake wash) − | |
| (water to sluice) | |
| Water in gyp slurry | 2,488 |
| Water of crystallization of gyp | 158 |
| Water in product acid | 30 |
| Water in scrubber fume | 6 |
| TOTAL WATER OUT | 14,954 |

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
amounts of chemical species (e.g. P₂O₅, MgO, Mg, etc.) indicated by % are by weight unless otherwise indicated. Ratios of amounts of chemical species are by weight unless otherwise indicated;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

While processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

Where a component (e.g. a sub-system, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B even where A and B are described in different sentences, paragraphs, or sections of this disclosure and/or in different claims (unless the description states otherwise or features A and B are fundamentally incompatible).

Any embodiments described in the foregoing or otherwise depicted in the application may be described or otherwise depicted as having more than one feature, arrangement of features, or combination of features. However, it is also contemplated that other embodiment(s) can have only any one or more of those features, arrangement(s), and/or combination(s). For example, where an embodiment is described or otherwise depicted as having features A, B, C, and D, a further embodiment may have features A and C only even if not explicitly described or depicted. As another example, further embodiments may have any combination of A, C, and D, including features A, C, D, and L, for example. Further, it is also contemplated that other embodiment(s) can have one or more or all features described or otherwise depicted for one or more other embodiment(s). For example, if a first embodiment is described or otherwise depicted as having features E, F, G, and H and a second embodiment is described or otherwise depicted as having features I, J, and K, a further embodiment may have features F, G, and J only even if not explicitly described or depicted. As another example, further embodiments may have features F, G, J, and M.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A phosphate processing system comprising:
a phosphoric acid plant operative to react a phosphate rock and an acid to produce a phosphoric acid product and a filter cake by-product; and
a granulation system connected to receive the phosphoric acid product and operative to produce a phosphate-containing fertilizer product.

2. The phosphate processing system according to claim 1 wherein the phosphoric acid plant and the granulation system collectively operate with a negative water balance.

3. The phosphate processing system according to claim 1 wherein the granulation system is operative to generate struvite as the phosphate-containing fertilizer product.

4. The phosphate processing system according to claim 1 further comprising a pond water treatment system connected to collect an aqueous phosphate solution discharged from the phosphoric acid plant.

5. The phosphate processing system according to claim 4 further comprising a precipitation system connected to receive the aqueous phosphate solution from the pond water treatment system and is operative to purify the received solution to generate one or more of a stream of treated water, a stream of sludge and a stream of effluent.

6. The phosphate processing system according to claim 5 wherein the phosphoric acid plant is connected to receive from the precipitation system the stream of sludge or a portion of the sludge containing elevated phosphate content from the pond water treatment system for use in producing the phosphoric acid product.

7. The phosphate processing system according to claim 1 further comprising a rinsing system connected to receive one or more input streams of rinsing fluid and is operative to rinse the filter cake by-product to produce a filtrate, wherein the phosphoric acid plant is connected to receive the filtrate for use in producing the phosphoric acid product.

8. The phosphate processing system according to claim 5 further comprising a rinsing system connected to receive one or more input streams of rinsing fluid and is operative to rinse the filter cake by-product to produce a filtrate, wherein the phosphoric acid plant is connected to receive the filtrate for use in producing the phosphoric acid product.

9. The phosphate processing system according to claim 7 wherein the one or more input streams of rinsing fluid comprises fresh water.

10. The phosphate processing system according to claim 9 wherein an amount of the fresh water supplied to the rinsing system as the rinsing fluid is equal to or less than an amount of water consumed by the production of struvite.

11. The phosphate processing system according to claim 8 wherein the one or more input streams of rinsing fluid comprises the stream of treated water produced in the precipitation system.

12. The phosphate processing system according to claim 4 further comprising an exhaust treatment system connected to collect exhaust gases and/or vapors released from the granulation system and is operative to separate from the collected exhaust gases and/or vapors solid particles contained therein, wherein the exhaust treatment system is connected to supply the solid particles to one or more of the granulation system, a crystallizer, and the pond water treatment system.

13. The phosphate processing system according to claim 5 further comprising an exhaust treatment system connected to collect exhaust gases and/or vapors released from the granulation system and is operative to separate from the collected exhaust gases and/or vapors solid particles contained therein, wherein the exhaust treatment system is connected to supply the solid particles to one or more of the granulation system, a crystallizer, and the pond water treatment system.

14. The phosphate processing system according to claim 12 wherein the exhaust treatment system comprises a scrubber operable to mix a scrubber fluid with the exhaust gases and/or vapors to produce a scrubber slurry comprising the solid particles.

15. The phosphate processing system according to claim 12 wherein the exhaust treatment system comprises a fines clarifier operative to separate fine dust particles from the solid particles.

16. The phosphate processing system according to claim 12 wherein the exhaust treatment system comprises a dewatering system operative to concentrate the separated fine dust particles.

17. The phosphate processing system according to claim 16 wherein the granulation system is connected to receive from the dewatering system the concentrated fine dust particles for use in the granulation process.

18. The phosphate processing system according claim 1 further comprising an organics removal system for removing organic matter from an organic phosphate containing material to form a phosphate containing solution, the organics removal system is connected to supply the phosphate containing solution to one or more of the granulation system and phosphoric acid plant.

19. The phosphate processing system according to claim 13 further comprising an organics removal system for removing organic matter from an organic phosphate containing material to form a phosphate containing solution, the organics removal system is connected to supply the phosphate containing solution to one or more of the granulation system and phosphoric acid plant.

20. The phosphate processing system according to claim 19 wherein the organic phosphate containing material comprises animal manure and/or poultry litter.

21. The phosphate processing system according to claim 19 wherein the crystallizer is connected to receive one or more streams from the precipitation system, the exhaust treatment system and the organics removal system, and wherein the crystallizer is operative to produce phosphate containing particles from the one or more streams.

22. The phosphate processing system according to claim 21 wherein the crystallizer is a fluidized bed crystallizer.

23. The phosphate processing system according to claim 21 wherein the stream from the precipitation system comprises the stream of effluent.

24. The phosphate processing system according to claim 21 wherein the stream from the exhaust treatment system comprises separated fine dust particles produced at a fines clarifier.

25. The phosphate processing system according to claim 21 wherein the stream from the organics removal system comprises the phosphate containing solution.

26. The phosphate processing system according to claim 21 wherein the granulation system is connected to receive from the crystallizer the phosphate containing particles to produce the phosphate-containing fertilizer product with the phosphoric acid product.

27. The phosphate processing system according to claim 26 wherein the phosphate containing particles comprise struvite.

28. The phosphate processing system according to claim 1 wherein the phosphate rock comprises a source of magnesium having a concentration greater than about 3% by weight of the total mineral content of the phosphate rock when expressed as MgO.

29. (canceled)

30. (canceled)

31. The phosphate processing system according to claim 1 wherein the phosphoric acid product has a concentration lower than 54% by weight.

32. (canceled)

33. (canceled)

34. The phosphate processing system according to claim 5 further comprising a membrane filtration system connected to receive the aqueous phosphate solution from the pond water treatment system and is operative to concentrate the aqueous phosphate solution to produce a concentrate and a clean water permeate stream.

35. The phosphate processing system according to claim 8 further comprising a membrane filtration system connected to receive the aqueous phosphate solution from the pond water treatment system and is operative to concentrate the aqueous phosphate solution to produce a concentrate and a clean water permeate stream.

36. The phosphate processing system according to claim 34 wherein the precipitation system is connected to receive the concentrate from the membrane filtration system and wherein the concentrate is purified at the precipitation system.

37. The phosphate processing system according to claim 35 wherein the one or more input streams of rinsing fluid comprises the clean water permeate stream produced from the membrane filtration system.

38. The phosphate processing system according to claim 1 wherein the acid comprises sulfuric acid and the filter cake by-product comprises gypsum.

39. The phosphate processing system according to claim 5 wherein the precipitation system produces from the purification of the aqueous phosphate solution received from the pond water system a source of phosphate, fluoride and/or gypsum.

40. The phosphate processing system according to claim 27 further comprising a heating system operative to heat the struvite produced at the crystallizer to produce dittmarite.

41. The phosphate processing system according to claim 40 wherein the granulation system receives from the crystallizer the produced dittmarite to generate the phosphate-containing fertilizer product.

42. The phosphate processing system according to claim 41 wherein the granulation system is operative to co-granulate the received struvite and/or dittmarite with one or more of monoammonium phosphate (MAP), di-ammonium phosphate (DAP) and triple-superphosphate (TSP) to produce the phosphate-containing fertilizer product.

43. The phosphate processing system according to claim 1, wherein the granulation system is connected to receive a source of one or more micronutrients and macronutrients to produce the phosphate-containing fertilizer product.

44. The phosphate processing system according to claim 1, wherein the granulation system is operated at a temperature below 60° C.

45. The phosphate processing system according to claim 1, wherein the granulation system is operated at a temperature above 60° C.

46. (canceled)

47. (canceled)

48. (canceled)

49. The phosphate processing system according to claim 1 wherein the phosphoric acid contains magnesium at a concentration such that a mole ratio of Mg:P in the phosphoric acid product is greater than 1:15.

50. The phosphate processing system according to claim 1 further comprising a source of ammonia connected to deliver ammonia to the granulation system.

51. The phosphate processing system according to claim 1, wherein the granulation system uses a magnesium source from the phosphate rock to produce the phosphate-containing fertilizer product.

52. The phosphate processing system according to claim 1 further comprising a delivery system connected to supply a source of additional magnesium to the granulation system for producing the phosphate-containing fertilizer product.

53. A phosphate processing system comprising:
a phosphoric acid plant operative to react a phosphate rock and an acid to produce a phosphoric acid product and a filter cake by-product;
a pond water treatment system operative to collect water discharged from the phosphoric acid plant;
a precipitation system operative to receive contaminated water from the pond water treatment system and purifying the received contaminated water to generate one or more of a stream of treated water, a stream of effluent, and a stream of sludge;
a rinsing system operative to receive one or more input streams of rinsing fluid to rinse the filter cake by-product;
an exhaust treatment system operative to collect exhaust gases and/or vapors released from the granulation system and to process the exhaust gases and/or vapors to separate solid particles contained therein; and
a granulation system operative to receive the phosphoric acid product and an input stream comprising phosphate containing particles to produce a phosphate-containing fertilizer product.

54-100. (canceled)
